(19) United States
(12) Patent Application Publication
(10) Pub. No.: US 2025/0153735 A1
(43) Pub. Date: May 15, 2025

(54) TECHNIQUES FOR ADAPTIVE DRIVING USING LANGUAGE MODELS

(71) Applicant: NVIDIA CORPORATION, Santa Clara, CA (US)

(72) Inventors: Boyi LI, New York, NY (US); Boris IVANOVIC, Mountain View, CA (US); Karen LEUNG, Seattle, WA (US); Marco PAVONE, Stanford, CA (US); Sushant VEER, Sunnyvale, CA (US); Yue WANG, Los Angeles, CA (US)

(21) Appl. No.: 18/933,354

(22) Filed: Oct. 31, 2024

Related U.S. Application Data
(60) Provisional application No. 63/548,344, filed on Nov. 13, 2023.

(51) Int. Cl. B60W 60/00; B60W 50/14; G06F 40/289; G06V 10/82; G06V 20/56

(52) U.S. Cl. CPC B60W 60/0011; B60W 50/14; G06F 40/289; G06V 10/82; G06V 20/56; B60W 2050/143; B60W 2050/146; B60W 2420/403; B60W 2555/60

(57) ABSTRACT

One embodiment of a method for controlling a vehicle includes receiving first text that includes a description of a scene and a first plan for driving a vehicle, extracting at least one portion of a set of traffic rules based on the description of the scene and the first plan, generating a first prompt that requests driving instructions and includes the description of the scene, the first plan, and the at least one portion of the set of traffic rules, processing the first prompt via a first trained language model to generate a second plan for driving the vehicle, and generating driving instructions based on the second plan.

### CROSS-REFERENCE TO RELATED APPLICATIONS

This application claims benefit of the United States Provisional patent application titled “ADAPTIVE POLICY SELECTION FOR AUTONOMOUS MACHINE OPERATION USING GENERATIVE PRE-TRAINED TRANSFORMER MODELS,” filed Nov. 13, 2023, and having Ser. No. 63/548,344. The subject matter of this related application is hereby incorporated herein by reference.

### BACKGROUND

### Field of the Various Embodiments

The embodiments of the present disclosure relate generally to the fields of computer science, machine learning and artificial intelligence (AI), and autonomous vehicles, and more specifically, to techniques for adaptive driving using language models.

### Description of the Related Art

Machine learning can be used to discover trends, patterns, relationships, and/or other attributes related to large sets of complex, interconnected, and/or multidimensional data. To glean insights from large data sets, artificial neural networks, regression models, support vector machines, decision trees, naïve Bayes classifiers, and/or other types of machine learning models can be trained using input-output pairs in the data. In turn, the trained machine learning models can be used to guide decisions and/or perform tasks related to the data and/or other similar data.

One type of task that machine learning models can be trained to perform is controlling vehicles, such as autonomous and semiautonomous vehicles. Typically, when a machine learning model is used to control a vehicle, the machine learning model is trained to adhere to a specific set of traffic rules. However, traffic rules can vary significantly across different geographic locations where a vehicle may end up driving. For example, some locations could require the vehicle to drive on the left side of the road, whereas other locations could require the vehicle to drive on the right side of the road. As another example, turning right on red lights could be permitted in some locations but not others.

When a vehicle is controlled by a machine learning model that is trained to adhere to a specific set of traffic rules, the resulting trained model can end up controlling the vehicle in erroneous ways that contravene local traffic rules, where those local traffic rules are different from the specific set of traffic rules. Such erroneous vehicle control can result in dangerous driving scenarios that raise safety concerns. Accordingly, conventional autonomous vehicles are usually limited to operating primarily in geo-fenced areas where the traffic rules do not change. Limiting the operation of conventional autonomous vehicles to geo-fenced areas can reduce the utility of those autonomous vehicles in transporting passengers to or from any locations that are outside the geo-fenced areas.

As the foregoing illustrates, what is needed in the art are more effective techniques for controlling vehicles using machine learning models.

### Summary

One embodiment of the present disclosure sets forth a computer-implemented method for controlling a vehicle. The method includes receiving first text that includes a description of a scene and a first plan for driving a vehicle, and extracting at least one portion of a set of traffic rules based on the description of the scene and the first plan. The method also includes generating a first prompt that requests driving instructions and includes the description of the scene, the first plan, and the at least one portion of the set of traffic rules. The method further includes processing the first prompt via a first trained language model to generate a second plan for driving the vehicle. In addition, the method includes generating driving instructions based on the second plan.

Other embodiments of the present disclosure include, without limitation, one or more computer-readable media including instructions for performing one or more aspects of the disclosed techniques as well as one or more computing systems for performing one or more aspects of the disclosed techniques.

At least one technical advantage of the disclosed techniques relative to the prior art is that the disclosed techniques enable a vehicle that is being controlled using a trained machine learning model to adapt to the traffic rules in different geographical locations. Accordingly, the disclosed techniques, when implemented to control a vehicle using a trained machine learning model, can result in the vehicle being driven in a manner that adheres to local traffic rules and is safer than what can typically be achieved using conventional machine learning models. Alternatively, the disclosed techniques, when implemented to respond to user input, can enable a user to drive more safely and in accordance with local traffic rules. These technical advantages represent one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a block diagram of a computing system configured to implement one or more aspects of the various embodiments;

FIG. 2A is an illustration of an exemplar autonomous vehicle, according to various embodiments;

FIG. 2B illustrates exemplar camera locations and fields of view for the exemplar autonomous vehicle of FIG. 2A, according to various embodiments;

FIG. 2C is a block diagram of an exemplar system architecture for the exemplar autonomous vehicle of FIG. 2A, according to various embodiments;

FIG. 2D is a system diagram for communication between cloud-based server(s) and the exemplar autonomous vehicle of FIG. 2A, according to various embodiments;

FIG. 3 is a more detailed illustration of the language model driving assistant of FIG. 1, according to various embodiments;

FIG. 4 illustrates an autonomous vehicle (AV) application that includes the language model driving assistant of FIG. 1, according to various embodiments;

FIG. 5 illustrates a navigation application that includes the language model driving assistant of FIG. 1, according to various embodiments;

FIG. 6 illustrates how an exemplar plan can be generated by the navigation application of FIG. 5, according to various embodiments;

FIG. 7 is a flow diagram of method steps for providing driving assistance to an autonomous vehicle or a user, according to various embodiments; and

FIG. 8 is a flow diagram of method steps for extracting portions of local traffic rules, according to various embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

### General Overview

Embodiments of the present disclosure provide techniques for generating driving instructions to autonomous vehicles or users. In some embodiments, a language model driving assistant receives as input text describing a scene, a plan for driving a vehicle, a current situation, and traffic rules for a geographic location in which the vehicle is being driven. Given such inputs, the language model driving assistant extracts one or more portions of the traffic rules that are relevant to the scene description, the plan, and/or the situation. For example, in some embodiments, the language model driving assistant can prompt a trained language model to extract, from the scene description, the plan, and/or the current situation, one or more keywords that include common traffic-related phrases. In such cases, the language model driving assistant can also search for the keyword(s) in the traffic rules, and then extract portions (e.g., paragraphs) of the traffic rules that include the keyword(s). The language model driving assistant further prompts the trained language model to generate an updated plan for driving the vehicle that accounts for the portion(s) of the traffic rules. The updated plan can be output as driving instructions to a user via a display device and/or speaker. Alternatively, the updated plan can be used to update an automatically generated motion plan, which can then be applied to control a vehicle.

The techniques for generating driving instructions to autonomous vehicles or users have many real-world applications. For example, those techniques could be used to control autonomous or semiautonomous vehicles within real-world or virtual environments. As another example, those techniques could be used to output driving instructions to a user via a display device and/or an audio device.

The above examples are not in any way intended to be limiting. As persons skilled in the art will appreciate, as a general matter, the techniques for generating driving instructions that are described herein can be implemented in any suitable application.

### System Overview

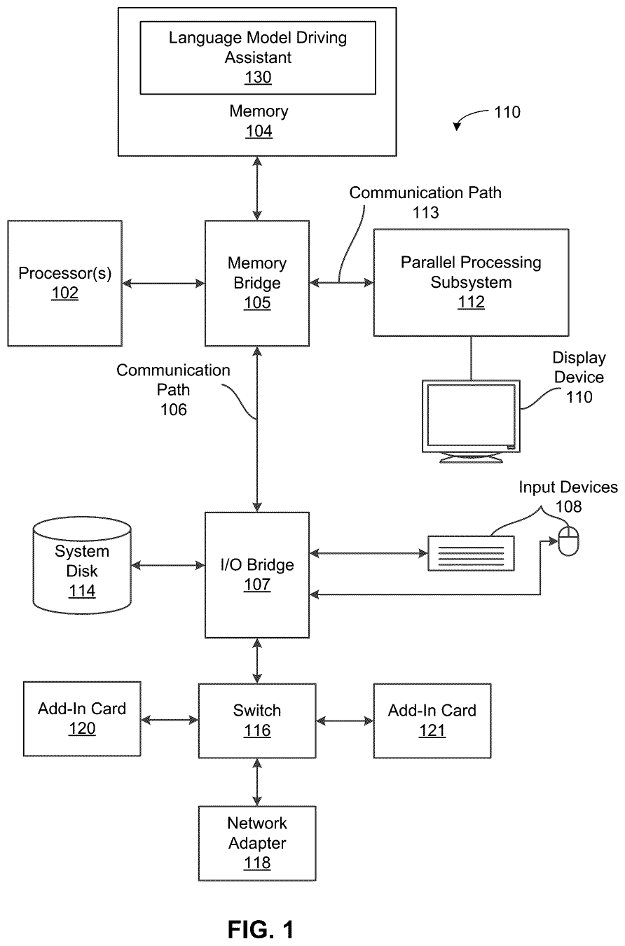

FIG. 1 illustrates a block diagram of a computing system 100 configured to implement one or more aspects of various embodiments. In some embodiments, the computing system 100 can include any type of computing system, including, without limitation, a server machine, a server platform, a desktop machine, a laptop machine, a hand-held/mobile device, a digital kiosk, an in-vehicle infotainment system, and/or a wearable device. In some embodiments, the computing system 100 is a server machine operating in a data center or a cloud computing environment that provides scalable computing resources as a service over a network.

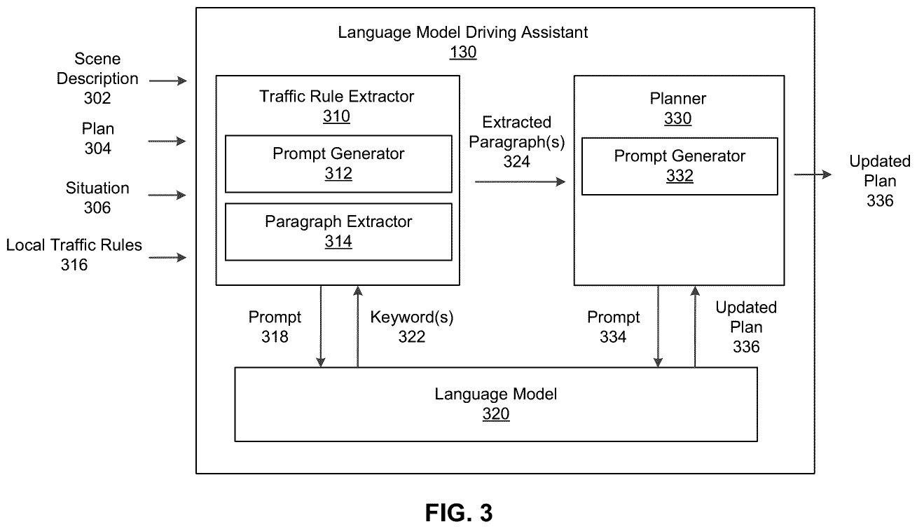

In some embodiments, the computing system 100 includes, without limitation, the processor(s) 112 and the memory(ies) 114 coupled to a parallel processing subsystem 112 via a memory bridge 105 and a communication path 106. A language model driving assistant 130, which is described in greater detail below in conjunction with FIGS. 3-8, is stored in the memor(ies) 114, and executes on the processor(s) 112 of the computing system 100. Although described herein primarily with respect to the language model driving assistant 13, techniques disclosed herein can also be implemented, either entirely or in part, in other software and/or hardware, such as in the parallel processing subsystem 112. Memory bridge 105 is further coupled to an I/O (input/output) bridge 107 via a communication path 106, and I/O bridge 107 is, in turn, coupled to a switch 116.

In some embodiments, the I/O bridge 107 is configured to receive user input information from optional input devices 108, such as a keyboard, mouse, touch screen, sensor data analysis (e.g., evaluating gestures, speech, or other information about one or more uses in a field of view or sensory field of one or more sensors), and/or the like, and forward the input information to the processor(s) 112 for processing. In some embodiments, the computing system 100 can be a server machine in a cloud computing environment. In such embodiments, the computing system 100 can not include input devices 108, but can receive equivalent input information by receiving commands (e.g., responsive to one or more inputs from a remote computing device) in the form of messages transmitted over a network and received via a network adapter 118. In some embodiments, the switch 116 is configured to provide connections between I/O bridge 107 and other components of the computing system 100, such as a network adapter 118 and various add in cards 120 and 121.

In some embodiments, the I/O bridge 107 is coupled to a system disk 114 that may be configured to store content and applications and data for use by the processor(s) 112 and the parallel processing subsystem 112. In some embodiments, the system disk 114 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high-definition DVD), or other magnetic, optical, or solid state storage devices. In some embodiments, other components, such as universal serial bus or other port connections, compact disc drives, digital versatile disc drives, film recording devices, and the like, may be connected to the I/O bridge 107 as well.

In some embodiments, the memory bridge 105 may be a Northbridge chip, and the I/O bridge 107 may be a Southbridge chip. In addition, the communication paths 106 and 113, as well as other communication paths within the computing system 100, can be implemented using any technically suitable protocols, including, without limitation, AGP (Accelerated Graphics Port), HyperTransport, or any other bus or point to point communication protocol known in the art.

In some embodiments, the parallel processing subsystem 112 comprises a graphics subsystem that delivers pixels to an optional display device 110 that may be any conventional cathode ray tube, liquid crystal display, light-emitting diode display, and/or the like. In such embodiments, the parallel processing subsystem 112 may incorporate circuitry optimized for graphics and video processing, including, for example, video output circuitry. Such circuitry may be incorporated across one or more parallel processing units (PPUs), also referred to herein as parallel processors, included within the parallel processing subsystem 112.

In some embodiments, the parallel processing subsystem 112 incorporates circuitry optimized (e.g., that undergoes optimization) for general purpose and/or compute processing. Again, such circuitry may be incorporated across one or more PPUs included within the parallel processing subsystem 112 that are configured to perform such general purpose and/or compute operations. In yet other embodiments, the one or more PPUs included within the parallel processing subsystem 112 may be configured to perform graphics processing, general purpose processing, and/or compute processing operations. The system memory 114 includes at least one device driver configured to manage the processing operations of the one or more PPUs within the parallel processing subsystem 112.

In some embodiments, the parallel processing subsystem 112 can be integrated with one or more of the other elements of FIG. 1 to form a single system. For example, the parallel processing subsystem 112 can be integrated with the processor(s) 112 and other connection circuitry on a single chip to form a system on a chip (SoC).

In some embodiments, the processor(s) 112 includes the primary processor of the computing system 100, controlling and coordinating operations of other system components. In some embodiments, the processor(s) 112 issues commands that control the operation of PPUs. In some embodiments, the communication path 113 is a PCI Express link, in which dedicated lanes are allocated to each PPU. Other communication paths may also be used. The PPU advantageously implements a highly parallel processing architecture, and the PPU may be provided with any amount of local parallel processing memory (PP memory).

It will be appreciated that the system shown herein is illustrative and that variations and modifications are possible. The connection topology, including the number and arrangement of bridges, the number of processor(s) 112, and the number of parallel processing subsystems 112, can be modified as desired. For example, in some embodiments, the system memory 114 could be connected to the processor(s) 112 directly rather than through the memory bridge 105, and other devices can communicate with the system memory 114 via the memory bridge 105 and the processor(s) 112. In other embodiments, the parallel processing subsystem 112 can be connected to the I/O bridge 107 or directly to the processor(s) 112, rather than to the memory bridge 105. In still other embodiments, the I/O bridge 107 and the memory bridge 105 can be integrated into a single chip instead of existing as one or more discrete devices. In certain embodiments, one or more components shown in FIG. 1 may not be present. For example, the switch 116 could be eliminated, and the network adapter 118 and add in cards 120, 121 would connect directly to the I/O bridge 107. Lastly, in certain embodiments, one or more components shown in FIG. 1 may be implemented as virtualized resources in a virtual computing environment, such as a cloud computing environment. In particular, the parallel processing subsystem 112 may be implemented as a virtualized parallel processing subsystem in some embodiments. For example, the parallel processing subsystem 112 may be implemented as a virtual graphics processing unit(s) (vGPU(s)) that renders graphics on a virtual machine(s) (VM(s)) executing on a server machine(s) whose GPU(s) and other physical resources are shared across one or more VMs.

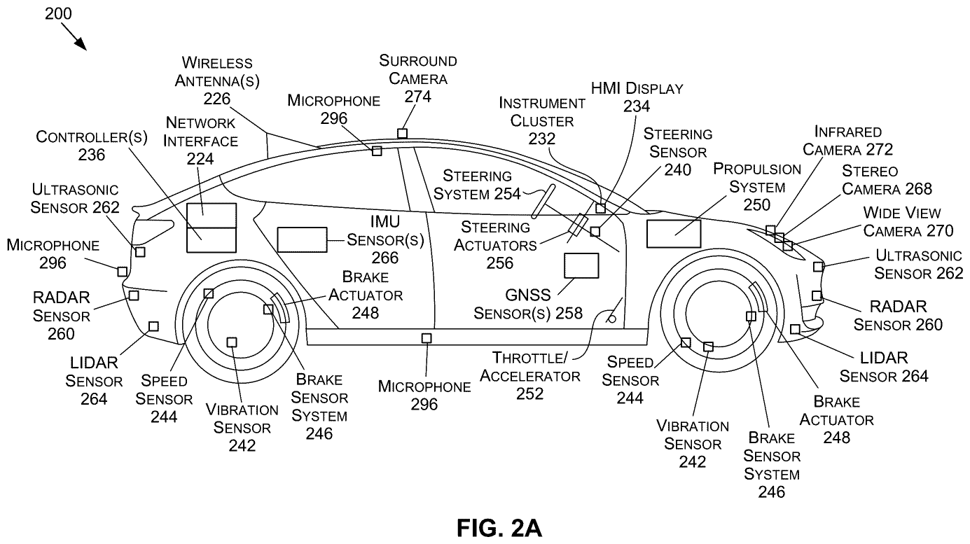

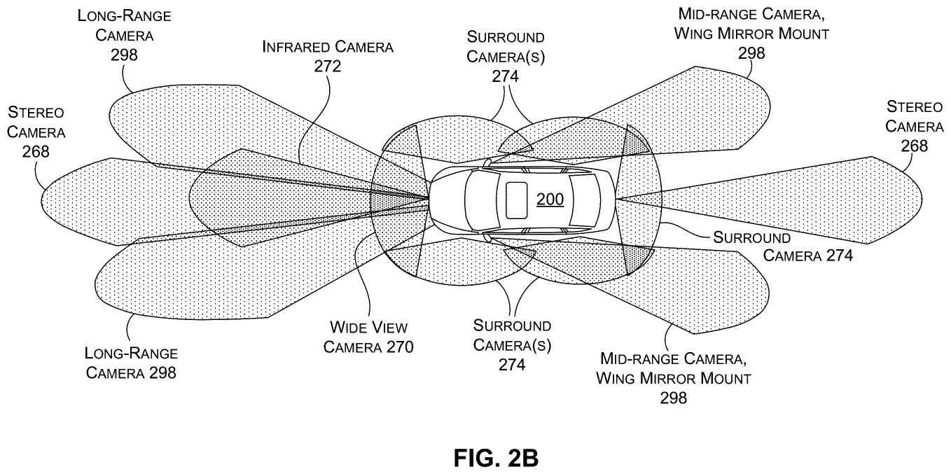

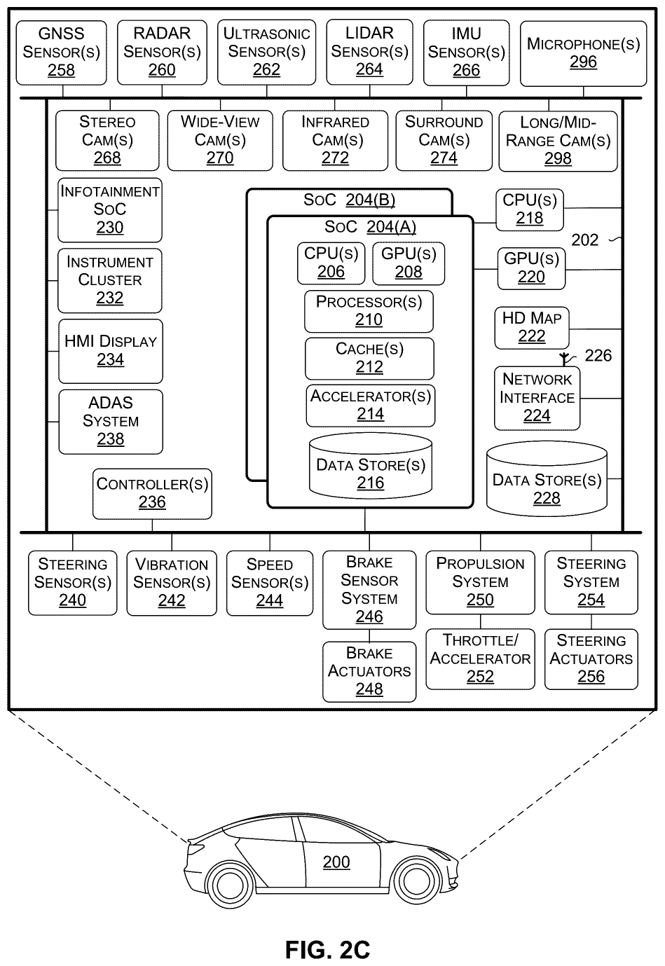

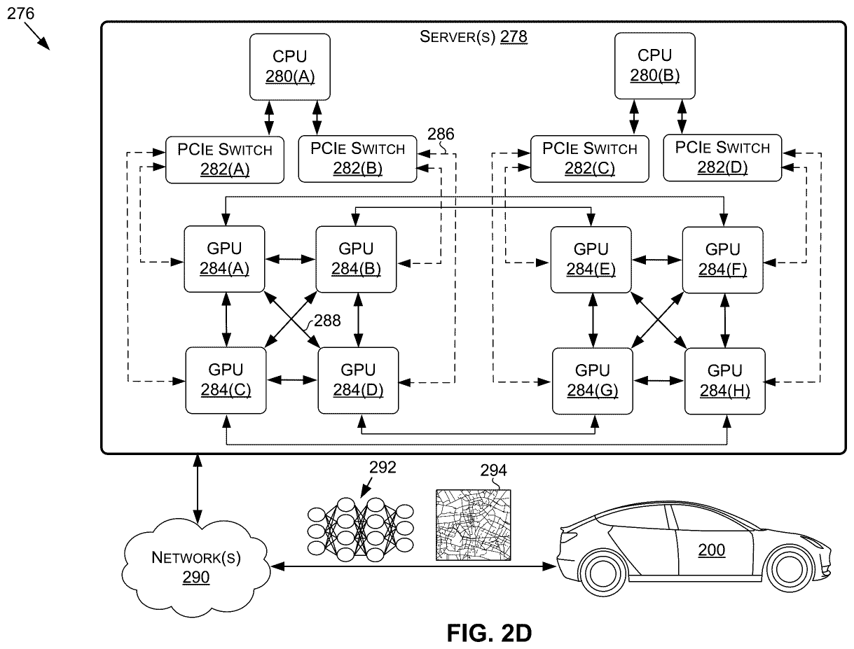

In some embodiments, the computing system 100 described herein can be executed using similar components, features, and/or functionality to those of example autonomous vehicle 200 of FIGS. 2A-2D. The systems and methods described herein may be used by, without limitation, non-autonomous vehicles, semi-autonomous vehicles (e.g., in one or more adaptive driver assistance systems (ADAS)), piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems implemented at least partially using cloud computing resources, and/or other types of systems.

### Exemplar Autonomous Vehicle

FIG. 2A is an illustration of an exemplar autonomous vehicle 200, according to various embodiments. The autonomous vehicle 200 (alternatively referred to herein as the “vehicle 200”) may include, without limitation, a passenger vehicle, such as a car, a truck, a bus, a first responder vehicle, a shuttle, an electric or motorized bicycle, a motorcycle, a fire truck, a police vehicle, an ambulance, a boat, a construction vehicle, an underwater craft, a robotic vehicle, a drone, an airplane, a vehicle coupled to a trailer (e.g., a semi-tractor-trailer truck used for hauling cargo), and/or another type of vehicle (e.g., that is unmanned and/or that accommodates one or more passengers). Autonomous vehicles are generally described in terms of automation levels, defined by the National Highway Traffic Safety Administration (NHTSA), a division of the US Department of Transportation, and the Society of Automotive Engineers (SAE) “Taxonomy and Definitions for Terms Related to Driving Automation Systems for On-Road Motor Vehicles” (Standard No. J3016-201806, published on Jun. 15, 2018, Standard No. J3016-201609, published on Sep. 30, 2016, and previous and future versions of this standard). The vehicle 200 may be capable of functionality in accordance with one or more of Level 3-Level 5 of the autonomous driving levels. The vehicle 200 may be capable of functionality in accordance with one or more of Level 1-Level 5 of the autonomous driving levels. For example, the vehicle 200 may be capable of driver assistance (Level 1), partial automation (Level 2), conditional automation (Level 3), high automation (Level 4), and/or full automation (Level 5), depending on the embodiment. The term “autonomous,” as used herein, may include any and/or all types of autonomy for the vehicle 200 or other machine, such as being fully autonomous, being highly autonomous, being conditionally autonomous, being partially autonomous, providing assistive autonomy, being semi-autonomous, being primarily autonomous, or other designation.

The vehicle 200 may include components such as a chassis, a vehicle body, wheels (e.g., 2, 4, 6, 8, 18, etc.), tires, axles, and other components of a vehicle. The vehicle 200 may include a propulsion system 250, such as an internal combustion engine, hybrid electric power plant, an all-electric engine, and/or another propulsion system type. The propulsion system 250 may be connected to a drive train of the vehicle 200, which may include a transmission, to enable the propulsion of the vehicle 200. The propulsion system 250 may be controlled in response to receiving signals from the throttle/accelerator 252.

A steering system 254, which may include a steering wheel, may be used to steer the vehicle 200 (e.g., along a desired path or route) when the propulsion system 250 is operating (e.g., when the vehicle is in motion). The steering system 254 may receive signals from a steering actuator 256. The steering wheel may be optional for full automation (Level 5) functionality.

The brake sensor system 246 may be used to operate the vehicle brakes in response to receiving signals from the brake actuators 248 and/or brake sensors.

Controller(s) 236, which may include one or more system on chips (SoCs) 204 (FIG. 2C) and/or GPU(s), may provide signals (e.g., representative of commands) to one or more components and/or systems of the vehicle 200. For example, the controller(s) may send signals to operate the vehicle brakes via one or more brake actuators 248, to operate the steering system 254 via one or more steering actuators 256, to operate the propulsion system 250 via one or more throttle/accelerators 252. The controller(s) 236 may include one or more onboard (e.g., integrated) computing devices (e.g., supercomputers) that process sensor signals, and output operation commands (e.g., signals representing commands) to enable autonomous driving and/or to assist a human driver in driving the vehicle 200. The controller(s) 236 may include a first controller 236 for autonomous driving functions, a second controller 236 for functional safety functions, a third controller 236 for artificial intelligence functionality (e.g., computer vision), a fourth controller 236 for infotainment functionality, a fifth controller 236 for redundancy in emergency conditions, and/or other controllers. In some examples, a single controller 236 may handle two or more of the above functionalities, two or more controllers 236 may handle a single functionality, and/or any combination thereof.

The controller(s) 236 may provide the signals for controlling one or more components and/or systems of the vehicle 200 in response to sensor data received from one or more sensors (e.g., sensor inputs). The sensor data may be received from, for example and without limitation, global navigation satellite systems (“GNSS”) sensor(s) 258 (e.g., Global Positioning System sensor(s)), RADAR sensor(s) 260, ultrasonic sensor(s) 262, LIDAR sensor(s) 264, inertial measurement unit (IMU) sensor(s) 266 (e.g., accelerometer(s), gyroscope(s), magnetic compass(es), magnetometer(s), etc.), microphone(s) 296, stereo camera(s) 268, wide-view camera(s) 270 (e.g., fisheye cameras), infrared camera(s) 272, surround camera(s) 274 (e.g., 360 degree cameras), long-range and/or mid-range camera(s) 298, speed sensor(s) 244 (e.g., for measuring the speed of the vehicle 200), vibration sensor(s) 242, steering sensor(s) 240, brake sensor(s) (e.g., as part of the brake sensor system 246), and/or other sensor types.

One or more of the controller(s) 236 may receive inputs (e.g., represented by input data) from an instrument cluster 232 of the vehicle 200 and provide outputs (e, represented by output data, display data, etc.) via a human-machine interface (HMI) display 234, an audible annunciator, a loudspeaker, and/or via other components of the vehicle 200. The outputs may include information such as vehicle velocity, speed, time, map data (e.g., the High Definition (“HD”) map 222 of FIG. 2C), location data (e.g., the vehicle's 200 location, such as on a map), direction, location of other vehicles (e.g., an occupancy grid), information about objects and status of objects as perceived by the controller(s) 236, etc. For example, the HMI display 234 may display information about the presence of one or more objects (e.g., a street sign, caution sign, traffic light changing, etc.), and/or information about driving maneuvers the vehicle has made, is making, or will make (e.g., changing lanes now, taking exit 34B in two miles, etc.).

The vehicle 200 further includes a network interface 224 which may use one or more wireless antenna(s) 226 and/or modem(s) to communicate over one or more networks. For example, the network interface 224 may be capable of communication over Long-Term Evolution (“LTE”), Wideband Code Division Multiple Access (“WCDMA”), Universal Mobile Telecommunications System (“UMTS”), Global System for Mobile communication (“GSM”), IMT-CDMA Multi-Carrier (“CDMA2000”), etc. The wireless antenna(s) 226 may also enable communication between objects in the environment (e.g., vehicles, mobile devices, etc.), using local area network(s), such as Bluetooth, Bluetooth Low Energy (“LE”), Z-Wave, ZigBee, etc., and/or low power wide-area network(s) (“LPWANs”), such as LoRaWAN, SigFox, etc.

FIG. 2B illustrates exemplar camera locations and fields of view for the exemplar autonomous vehicle 200 of FIG. 2A, according to various embodiments. The cameras and respective fields of view are one example embodiment and are not intended to be limiting. For example, additional and/or alternative cameras may be included and/or the cameras may be located at different locations on the vehicle 200.

The camera types for the cameras may include, but are not limited to, digital cameras that may be adapted for use with the components and/or systems of the vehicle 200. The camera(s) may operate at automotive safety integrity level (ASIL) B and/or at another ASIL. The camera types may be capable of any image capture rate, such as 60 frames per second (fps), 120 fps, 240 fps, etc., depending on the embodiment. The cameras may be capable of using rolling shutters, global shutters, another type of shutter, or a combination thereof. In some examples, the color filter array may include a red clear clear clear (RCCC) color filter array, a red clear clear blue (RCCB) color filter array, a red blue green clear (RBGC) color filter array, a Foveon X3 color filter array, a Bayer sensors (RGGB) color filter array, a monochrome sensor color filter array, and/or another type of color filter array. In some embodiments, clear pixel cameras, such as cameras with an RCCC, an RCCB, and/or an RBGC color filter array, may be used in an effort to increase light sensitivity.

In some examples, one or more of the camera(s) may be used to perform advanced driver assistance systems (ADAS) functions (e.g., as part of a redundant or fail-safe design). For example, a Multi-Function Mono Camera may be installed to provide functions including lane departure warning, traffic sign assist and intelligent headlamp control. One or more of the camera(s) (e.g., all of the cameras) may record and provide image data (e.g., video) simultaneously.

One or more of the cameras may be mounted in a mounting assembly, such as a custom designed (three dimensional (“3D”) printed) assembly, in order to cut out stray light and reflections from within the car (e.g., reflections from the dashboard reflected in the windshield mirrors) which may interfere with the camera's image data capture abilities. With reference to wing-mirror mounting assemblies, the wing-mirror assemblies may be custom 3D printed so that the camera mounting plate matches the shape of the wing-mirror. In some examples, the camera(s) may be integrated into the wing-mirror. For side-view cameras, the camera(s) may also be integrated within the four pillars at each corner of the cabin.

Cameras with a field of view that include portions of the environment in front of the vehicle 200 (e.g., front-facing cameras) may be used for surround view, to help identify forward facing paths and obstacles, as well aid in, with the help of one or more controllers 236 and/or control SoCs, providing information critical to generating an occupancy grid and/or determining the preferred vehicle paths. Front-facing cameras may be used to perform many of the same ADAS functions as LIDAR, including emergency braking, pedestrian detection, and collision avoidance. Front-facing cameras may also be used for ADAS functions and systems including Lane Departure Warnings (“LDW”), Autonomous Cruise Control (“ACC”), and/or other functions such as traffic sign recognition.

A variety of cameras may be used in a front-facing configuration, including, for example, a monocular camera platform that includes a complementary metal oxide semiconductor (“CMOS”) color imager. Another example may be a wide-view camera(s) 270 that may be used to perceive objects coming into view from the periphery (e.g., pedestrians, crossing traffic or bicycles). Although only one wide-view camera is illustrated in FIG. 2B, there may be any number (including zero) of wide-view cameras 270 on the vehicle 200. In addition, any number of long-range camera(s) 298 (e.g., a long-view stereo camera pair) may be used for depth-based object detection, especially for objects for which a neural network has not yet been trained. The long-range camera(s) 298 may also be used for object detection and classification, as well as basic object tracking.

Any number of stereo cameras 268 may also be included in a front-facing configuration. In some embodiments, one or more of stereo camera(s) 268 may include an integrated control unit comprising a scalable processing unit, which may provide a programmable logic (“FPGA”) and a multi-core micro-processor with an integrated Controller Area Network (“CAN”) or Ethernet interface on a single chip. Such a unit may be used to generate a 3D map of the vehicle's environment, including a distance estimate for all the points in the image. An alternative stereo camera(s) 268 may include a compact stereo vision sensor(s) that may include two camera lenses (one each on the left and right) and an image processing chip that may measure the distance from the vehicle to the target object and use the generated information (e.g., metadata) to activate the autonomous emergency braking and lane departure warning functions. Other types of stereo camera(s) 268 may be used in addition to, or alternatively from, those described herein.

Cameras with a field of view that include portions of the environment to the side of the vehicle 200 (e.g., side-view cameras) may be used for surround view, providing information used to create and update the occupancy grid, as well as to generate side impact collision warnings. For example, surround camera(s) 274 (e.g., four surround cameras 274 as illustrated in FIG. 2B) may be positioned on the vehicle 200. The surround camera(s) 274 may include wide-view camera(s) 270, fisheye camera(s), 360 degree camera(s), and/or the like. Four example, four fisheye cameras may be positioned on the vehicle's front, rear, and sides. In an alternative arrangement, the vehicle may use three surround camera(s) 274 (e.g., left, right, and rear), and may leverage one or more other camera(s) (e.g., a forward-facing camera) as a fourth surround view camera.

Cameras with a field of view that include portions of the environment to the rear of the vehicle 200 (e.g., rear-view cameras) may be used for park assistance, surround view, rear collision warnings, and creating and updating the occupancy grid. A wide variety of cameras may be used including, but not limited to, cameras that are also suitable as a front-facing camera(s) (e.g., long-range and/or mid-range camera(s) 298, stereo camera(s) 268), infrared camera(s) 272, etc.), as described herein.

FIG. 2C is a block diagram of an exemplar system architecture for the exemplar autonomous vehicle 200 of FIG. 2A, according to various embodiments. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

Each of the components, features, and systems of the vehicle 200 in FIG. 2C are illustrated as being connected via bus 202. The bus 202 may include a Controller Area Network (CAN) data interface (alternatively referred to herein as a “CAN bus”). A CAN may be a network inside the vehicle 200 used to aid in control of various features and functionality of the vehicle 200, such as actuation of brakes, acceleration, braking, steering, windshield wipers, etc. A CAN bus may be configured to have dozens or even hundreds of nodes, each with its own unique identifier (e.g., a CAN ID). The CAN bus may be read to find steering wheel angle, ground speed, engine revolutions per minute (RPMs), button positions, and/or other vehicle status indicators. The CAN bus may be ASIL B compliant.

Although the bus 202 is described herein as being a CAN bus, this is not intended to be limiting. For example, in addition to, or alternatively from, the CAN bus, FlexRay and/or Ethernet may be used. Additionally, although a single line is used to represent the bus 202, this is not intended to be limiting. For example, there may be any number of busses 202, which may include one or more CAN busses, one or more FlexRay busses, one or more Ethernet busses, and/or one or more other types of busses using a different protocol. In some examples, two or more busses 202 may be used to perform different functions, and/or may be used for redundancy. For example, a first bus 202 may be used for collision avoidance functionality and a second bus 202 may be used for actuation control. In any example, each bus 202 may communicate with any of the components of the vehicle 200, and two or more busses 202 may communicate with the same components. In some examples, each SoC 204, each controller 236, and/or each computer within the vehicle may have access to the same input data (e.g., inputs from sensors of the vehicle 200), and may be connected to a common bus, such the CAN bus.

The vehicle 200 may include one or more controller(s) 236, such as those described herein with respect to FIG. 2A. The controller(s) 236 may be used for a variety of functions. The controller(s) 236 may be coupled to any of the various other components and systems of the vehicle 200, and may be used for control of the vehicle 200, artificial intelligence of the vehicle 200, infotainment for the vehicle 200, and/or the like.

The vehicle 200 may include a system(s) on a chip (SoC) 204. The SoC 204 may include CPU(s) 206, GPU(s) 208, processor(s) 210, cache(s) 212, accelerator(s) 214, data store(s) 216, and/or other components and features not illustrated. In some embodiments, components (e.g., CPU(s) 210 and data store(s) 216) included in the vehicle 200 can be the same as, or similar to, corresponding components (e.g., processor(s) 142 and memory(ies) 144) included in the computing system 100, described above in conjunction with FIG. 1. The SoC(s) 204 may be used to control the vehicle 200 in a variety of platforms and systems. For example, the SoC(s) 204 may be combined in a system (e.g., the system of the vehicle 200) with an HD map 222 which may obtain map refreshes and/or updates via a network interface 224 from one or more servers (e.g., server(s) 278 of FIG. 2D).

The CPU(s) 206 may include a CPU cluster or CPU complex (alternatively referred to herein as a “CCPLEX”). The CPU(s) 206 may include multiple cores and/or L2 caches. For example, in some embodiments, the CPU(s) 206 may include eight cores in a coherent multi-processor configuration. In some embodiments, the CPU(s) 206 may include four dual-core clusters where each cluster has a dedicated L2 cache (e.g., a 2 MB L2 cache). The CPU(s) 206 (e.g., the CCPLEX) may be configured to support simultaneous cluster operation enabling any combination of the clusters of the CPU(s) 206 to be active at any given time.

The CPU(s) 206 may implement power management capabilities that include one or more of the following features: individual hardware blocks may be clock-gated automatically when idle to save dynamic power; each core clock may be gated when the core is not actively executing instructions due to execution of WFI/WFE instructions; each core may be independently power-gated; each core cluster may be independently clock-gated when all cores are clock-gated or power-gated; and/or each core cluster may be independently power-gated when all cores are power-gated. The CPU(s) 206 may further implement an enhanced algorithm for managing power states, where allowed power states and expected wakeup times are specified, and the hardware/microcode determines the best power state to enter for the core, cluster, and CCPLEX. The processing cores may support simplified power state entry sequences in software with the work offloaded to microcode.

The GPU(s) 208 may include an integrated GPU (alternatively referred to herein as an “iGPU”). The GPU(s) 208 may be programmable and may be efficient for parallel workloads. The GPU(s) 208, in some examples, may use an enhanced tensor instruction set. The GPU(s) 208 may include one or more streaming microprocessors, where each streaming microprocessor may include an L1 cache (e.g., an L1 cache with at least 96 KB storage capacity), and two or more of the streaming microprocessors may share an L2 cache (e.g., an L2 cache with a 512 KB storage capacity). In some embodiments, the GPU(s) 208 may include at least eight streaming microprocessors. The GPU(s) 208 may use compute application programming interface(s) (API(s)). In addition, the GPU(s) 208 may use one or more parallel computing platforms and/or programming models (e.g., NVIDIA's CUDA).

The GPU(s) 208 may be power-optimized for best performance in automotive and embedded use cases. For example, the GPU(s) 208 may be fabricated on a Fin field-effect transistor (FinFET). However, this is not intended to be limiting and the GPU(s) 208 may be fabricated using other semiconductor manufacturing processes. Each streaming microprocessor may incorporate a number of mixed-precision processing cores partitioned into multiple blocks. For example, and without limitation, 64 PF32 cores and 32 PF64 cores may be partitioned into four processing blocks. In such an example, each processing block may be allocated 16 FP32 cores, 8 FP64 cores, 16 INT32 cores, two mixed-precision NVIDIA TENSOR COREs for deep learning matrix arithmetic, an L0 instruction cache, a warp scheduler, a dispatch unit, and/or a 64 KB register file. In addition, the streaming microprocessors may include independent parallel integer and floating-point data paths to provide for efficient execution of workloads with a mix of computation and addressing calculations. The streaming microprocessors may include independent thread scheduling capability to enable finer-grain synchronization and cooperation between parallel threads. The streaming microprocessors may include a combined L1 data cache and shared memory unit in order to improve performance while simplifying programming.

The GPU(s) 208 may include a high bandwidth memory (HBM) and/or a 16 GB HBM2 memory subsystem to provide, in some examples, about 900 GB/second peak memory bandwidth. In some examples, in addition to, or alternatively from, the HBM memory, a synchronous graphics random-access memory (SGRAM) may be used, such as a graphics double data rate type five synchronous random-access memory (GDDR5).

The GPU(s) 208 may include unified memory technology including access counters to allow for more accurate migration of memory pages to the processor that accesses them most frequently, thereby improving efficiency for memory ranges shared between processors. In some examples, address translation services (ATS) support may be used to allow the GPU(s) 208 to access the CPU(s) 206 page tables directly. In such examples, when the GPU(s) 208 memory management unit (MMU) experiences a miss, an address translation request may be transmitted to the CPU(s) 206. In response, the CPU(s) 206 may look in its page tables for the virtual-to-physical mapping for the address and transmits the translation back to the GPU(s) 208. As such, unified memory technology may allow a single unified virtual address space for memory of both the CPU(s) 206 and the GPU(s) 208, thereby simplifying the GPU(s) 208 programming and porting of applications to the GPU(s) 208.

In addition, the GPU(s) 208 may include an access counter that may keep track of the frequency of access of the GPU(s) 208 to memory of other processors. The access counter may help ensure that memory pages are moved to the physical memory of the processor that is accessing the pages most frequently.

The SoC(s) 204 may include any number of cache(s) 212, including those described herein. For example, the cache(s) 212 may include an L3 cache that is available to both the CPU(s) 206 and the GPU(s) 208 (e.g., that is connected both the CPU(s) 206 and the GPU(s) 208). The cache(s) 212 may include a write-back cache that may keep track of states of lines, such as by using a cache coherence protocol (e.g., MEI, MESI, MSI, etc.). The L3 cache may include 4 MB or more, depending on the embodiment, although smaller cache sizes may be used.

The SoC(s) 204 may include an arithmetic logic unit(s) (ALU(s)) which may be leveraged in performing processing with respect to any of the variety of tasks or operations of the vehicle 200—such as processing DNNs. In addition, the SoC(s) 204 may include a floating point unit(s) (FPU(s))—or other math coprocessor or numeric coprocessor types—for performing mathematical operations within the system. For example, the SoC(s) 104 may include one or more FPUs integrated as execution units within a CPU(s) 206 and/or GPU(s) 208.

The SoC(s) 204 may include one or more accelerators 214 (e.g., hardware accelerators, software accelerators, or a combination thereof). For example, the SoC(s) 204 may include a hardware acceleration cluster that may include optimized hardware accelerators and/or large on-chip memory. The large on-chip memory (e.g., 4 MB of SRAM), may enable the hardware acceleration cluster to accelerate neural networks and other calculations. The hardware acceleration cluster may be used to complement the GPU(s) 208 and to off-load some of the tasks of the GPU(s) 208 (e.g., to free up more cycles of the GPU(s) 208 for performing other tasks). As an example, the accelerator(s) 214 may be used for targeted workloads (e.g., perception, convolutional neural networks (CNNs), etc.) that are stable enough to be amenable to acceleration. The term “CNN,” as used herein, may include all types of CNNs, including region-based or regional convolutional neural networks (RCNNs) and Fast RCNNs (e.g., as used for object detection).

The accelerator(s) 214 (e.g., the hardware acceleration cluster) may include a deep learning accelerator(s) (DLA). The DLA(s) may include one or more Tensor processing units (TPUs) that may be configured to provide an additional ten trillion operations per second for deep learning applications and inferencing. The TPUs may be accelerators configured to, and optimized for, performing image processing functions (e.g., for CNNs, RCNNs, etc.). The DLA(s) may further be optimized for a specific set of neural network types and floating point operations, as well as inferencing. The design of the DLA(s) may provide more performance per millimeter than a general-purpose GPU, and vastly exceeds the performance of a CPU. The TPU(s) may perform several functions, including a single-instance convolution function, supporting, for example, INT8, INT16, and FP16 data types for both features and weights, as well as post-processor functions.

The DLA(s) may quickly and efficiently execute neural networks, especially CNNs, on processed or unprocessed data for any of a variety of functions, including, for example and without limitation: a CNN for object identification and detection using data from camera sensors; a CNN for distance estimation using data from camera sensors; a CNN for emergency vehicle detection and identification and detection using data from microphones; a CNN for facial recognition and vehicle owner identification using data from camera sensors; and/or a CNN for security and/or safety related events.

The DLA(s) may perform any function of the GPU(s) 208, and by using an inference accelerator, for example, a designer may target either the DLA(s) or the GPU(s) 208 for any function. For example, the designer may focus processing of CNNs and floating point operations on the DLA(s) and leave other functions to the GPU(s) 208 and/or other accelerator(s) 214.

The accelerator(s) 214 (e.g., the hardware acceleration cluster) may include a programmable vision accelerator(s) (PVA), which may alternatively be referred to herein as a computer vision accelerator. The PVA(s) may be designed and configured to accelerate computer vision algorithms for the advanced driver assistance systems (ADAS), autonomous driving, and/or augmented reality (AR) and/or virtual reality (VR) applications. The PVA(s) may provide a balance between performance and flexibility. For example, each PVA(s) may include, for example and without limitation, any number of reduced instruction set computer (RISC) cores, direct memory access (DMA), and/or any number of vector processors.

The RISC cores may interact with image sensors (e.g., the image sensors of any of the cameras described herein), image signal processor(s), and/or the like. Each of the RISC cores may include any amount of memory. The RISC cores may use any of a number of protocols, depending on the embodiment. In some examples, the RISC cores may execute a real-time operating system (RTOS). The RISC cores may be implemented using one or more integrated circuit devices, application specific integrated circuits (ASICs), and/or memory devices. For example, the RISC cores may include an instruction cache and/or a tightly coupled RAM.

The DMA may enable components of the PVA(s) to access the system memory independently of the CPU(s) 206. The DMA may support any number of features used to provide optimization to the PVA including, but not limited to, supporting multi-dimensional addressing and/or circular addressing. In some examples, the DMA may support up to six or more dimensions of addressing, which may include block width, block height, block depth, horizontal block stepping, vertical block stepping, and/or depth stepping.

The vector processors may be programmable processors that may be designed to efficiently and flexibly execute programming for computer vision algorithms and provide signal processing capabilities. In some examples, the PVA may include a PVA core and two vector processing subsystem partitions. The PVA core may include a processor subsystem, DMA engine(s) (e.g., two DMA engines), and/or other peripherals. The vector processing subsystem may operate as the primary processing engine of the PVA, and may include a vector processing unit (VPU), an instruction cache, and/or vector memory (e.g., VMEM). A VPU core may include a digital signal processor such as, for example, a single instruction, multiple data (SIMD), very long instruction word (VLIW) digital signal processor. The combination of the SIMD and VLIW may enhance throughput and speed.

Each of the vector processors may include an instruction cache and may be coupled to dedicated memory. As a result, in some examples, each of the vector processors may be configured to execute independently of the other vector processors. In other examples, the vector processors that are included in a particular PVA may be configured to employ data parallelism. For example, in some embodiments, the plurality of vector processors included in a single PVA may execute the same computer vision algorithm, but on different regions of an image. In other examples, the vector processors included in a particular PVA may simultaneously execute different computer vision algorithms, on the same image, or even execute different algorithms on sequential images or portions of an image. Among other things, any number of PVAs may be included in the hardware acceleration cluster and any number of vector processors may be included in each of the PVAs. In addition, the PVA(s) may include additional error correcting code (ECC) memory, to enhance overall system safety.

The accelerator(s) 214 (e.g., the hardware acceleration cluster) may include a computer vision network on-chip and SRAM, for providing a high-bandwidth, low latency SRAM for the accelerator(s) 214. In some examples, the on-chip memory may include at least 4 MB SRAM, consisting of, for example and without limitation, eight field-configurable memory blocks, that may be accessible by both the PVA and the DLA. Each pair of memory blocks may include an advanced peripheral bus (APB) interface, configuration circuitry, a controller, and a multiplexer. Any type of memory may be used. The PVA and DLA may access the memory via a backbone that provides the PVA and DLA with high-speed access to memory. The backbone may include a computer vision network on-chip that interconnects the PVA and the DLA to the memory (e.g., using the APB).

The computer vision network on-chip may include an interface that determines, before transmission of any control signal/address/data, that both the PVA and the DLA provide ready and valid signals. Such an interface may provide for separate phases and separate channels for transmitting control signals/addresses/data, as well as burst-type communications for continuous data transfer. This type of interface may comply with ISO 26262 or IEC 61508 standards, although other standards and protocols may be used.

In some examples, the SoC(s) 204 may include a real-time ray-tracing hardware accelerator, such as described in U.S. patent application Ser. No. 16/101,232, filed on Aug. 10, 2018. The real-time ray-tracing hardware accelerator may be used to quickly and efficiently determine the positions and extents of objects (e.g., within a world model), to generate real-time visualization simulations, for RADAR signal interpretation, for sound propagation synthesis and/or analysis, for simulation of SONAR systems, for general wave propagation simulation, for comparison to LIDAR data for purposes of localization and/or other functions, and/or for other uses. In some embodiments, one or more tree traversal units (TTUs) may be used for executing one or more ray-tracing related operations.

The accelerator(s) 214 (e.g., the hardware accelerator cluster) have a wide array of uses for autonomous driving. The PVA may be a programmable vision accelerator that may be used for key processing stages in ADAS and autonomous vehicles. The PVA's capabilities are a good match for algorithmic domains needing predictable processing, at low power and low latency. In other words, the PVA performs well on semi-dense or dense regular computation, even on small data sets, which need predictable run-times with low latency and low power. Thus, in the context of platforms for autonomous vehicles, the PVAs are designed to run classic computer vision algorithms, as they are efficient at object detection and operating on integer math.

For example, according to one embodiment of the technology, the PVA is used to perform computer stereo vision. A semi-global matching-based algorithm may be used in some examples, although this is not intended to be limiting. Many applications for Level 3-5 autonomous driving require motion estimation/stereo matching on-the-fly (e.g., structure from motion, pedestrian recognition, lane detection, etc.). The PVA may perform computer stereo vision function on inputs from two monocular cameras.

In some examples, the PVA may be used to perform dense optical flow. According to process raw RADAR data (e.g., using a 4D Fast Fourier Transform) to provide Processed RADAR. In other examples, the PVA is used for time of flight depth processing, by processing raw time of flight data to provide processed time of flight data, for example.

The DLA may be used to run any type of network to enhance control and driving safety, including for example, a neural network that outputs a measure of confidence for each object detection. Such a confidence value may be interpreted as a probability, or as providing a relative “weight” of each detection compared to other detections. This confidence value enables the system to make further decisions regarding which detections should be considered as true positive detections rather than false positive detections. For example, the system may set a threshold value for the confidence and consider only the detections exceeding the threshold value as true positive detections. In an automatic emergency braking (AEB) system, false positive detections would cause the vehicle to automatically perform emergency braking, which is obviously undesirable. Therefore, only the most confident detections should be considered as triggers for AEB. The DLA may run a neural network for regressing the confidence value. The neural network may take as its input at least some subset of parameters, such as bounding box dimensions, ground plane estimate obtained (e.g. from another subsystem), inertial measurement unit (IMU) sensor 266 output that correlates with the vehicle 200 orientation, distance, 3D location estimates of the object obtained from the neural network and/or other sensors (e.g., LIDAR sensor(s) 264 or RADAR sensor(s) 260), among others.

The SoC(s) 204 may include data store(s) 216 (e.g., memory). The data store(s) 216 may be on-chip memory of the SoC(s) 204, which may store neural networks to be executed on the GPU and/or the DLA. In some examples, the data store(s) 216 may be large enough in capacity to store multiple instances of neural networks for redundancy and safety. The data store(s) 212 may comprise L2 or L3 cache(s) 212. Reference to the data store(s) 216 may include reference to the memory associated with the PVA, DLA, and/or other accelerator(s) 214, as described herein.

The SoC(s) 204 may include one or more processor(s) 210 (e.g., embedded processors). The processor(s) 210 may include a boot and power management processor that may be a dedicated processor and subsystem to handle boot power and management functions and related security enforcement. The boot and power management processor may be a part of the SoC(s) 204 boot sequence and may provide runtime power management services. The boot power and management processor may provide clock and voltage programming, assistance in system low power state transitions, management of SoC(s) 204 thermals and temperature sensors, and/or management of the SoC(s) 204 power states. Each temperature sensor may be implemented as a ring-oscillator whose output frequency is proportional to temperature, and the SoC(s) 204 may use the ring-oscillators to detect temperatures of the CPU(s) 206, GPU(s) 208, and/or accelerator(s) 214. If temperatures are determined to exceed a threshold, the boot and power management processor may enter a temperature fault routine and put the SoC(s) 204 into a lower power state and/or put the vehicle 200 into a chauffeur to safe stop mode (e.g., bring the vehicle 200 to a safe stop).

The processor(s) 210 may further include a set of embedded processors that may serve as an audio processing engine. The audio processing engine may be an audio subsystem that enables full hardware support for multi-channel audio over multiple interfaces, and a broad and flexible range of audio I/O interfaces. In some examples, the audio processing engine is a dedicated processor core with a digital signal processor with dedicated RAM.

The processor(s) 210 may further include an always on processor engine that may provide necessary hardware features to support low power sensor management and wake use cases. The always on processor engine may include a processor core, a tightly coupled RAM, supporting peripherals (e.g., timers and interrupt controllers), various I/O controller peripherals, and routing logic.

The processor(s) 210 may further include a safety cluster engine that includes a dedicated processor subsystem to handle safety management for automotive applications. The safety cluster engine may include two or more processor cores, a tightly coupled RAM, support peripherals (e.g., timers, an interrupt controller, etc.), and/or routing logic. In a safety mode, the two or more cores may operate in a lockstep mode and function as a single core with comparison logic to detect any differences between their operations.

The processor(s) 210 may further include a real-time camera engine that may include a dedicated processor subsystem for handling real-time camera management.

The processor(s) 210 may further include a high-dynamic range signal processor that may include an image signal processor that is a hardware engine that is part of the camera processing pipeline.

The processor(s) 210 may include a video image compositor that may be a processing block (e.g., implemented on a microprocessor) that implements video post-processing functions needed by a video playback application to produce the final image for the player window. The video image compositor may perform lens distortion correction on wide-view camera(s) 270, surround camera(s) 274, and/or on in-cabin monitoring camera sensors. In-cabin monitoring camera sensor is preferably monitored by a neural network running on another instance of the Advanced SoC, configured to identify in cabin events and respond accordingly. An in-cabin system may perform lip reading to activate cellular service and place a phone call, dictate emails, change the vehicle's destination, activate or change the vehicle's infotainment system and settings, or provide voice-activated web surfing. Certain functions are available to the driver only when the vehicle is operating in an autonomous mode, and are disabled otherwise.

The video image compositor may include enhanced temporal noise reduction for both spatial and temporal noise reduction. For example, where motion occurs in a video, the noise reduction weights spatial information appropriately, decreasing the weight of information provided by adjacent frames. Where an image or portion of an image does not include motion, the temporal noise reduction performed by the video image compositor may use information from the previous image to reduce noise in the current image.

The video image compositor may also be configured to perform stereo rectification on input stereo lens frames. The video image compositor may further be used for user interface composition when the operating system desktop is in use, and the GPU(s) 208 is not required to continuously render new surfaces. Even when the GPU(s) 208 is powered on and active doing 3D rendering, the video image compositor may be used to offload the GPU(s) 208 to improve performance and responsiveness.

The SoC(s) 204 may further include a mobile industry processor interface (MIPI) camera serial interface for receiving video and input from cameras, a high-speed interface, and/or a video input block that may be used for camera and related pixel input functions. The SoC(s) 204 may further include an input/output controller(s) that may be controlled by software and may be used for receiving I/O signals that are uncommitted to a specific role.

The SoC(s) 204 may further include a broad range of peripheral interfaces to enable communication with peripherals, audio codecs, power management, and/or other devices. The SoC(s) 204 may be used to process data from cameras (e.g., connected over Gigabit Multimedia Serial Link and Ethernet), sensors (e.g., LIDAR sensor(s) 264, RADAR sensor(s) 260, etc. that may be connected over Ethernet), data from bus 202 (e.g., speed of vehicle 200, steering wheel position, etc.), data from GNSS sensor(s) 258 (e.g., connected over Ethernet or CAN bus). The SoC(s) 204 may further include dedicated high-performance mass storage controllers that may include their own DMA engines, and that may be used to free the CPU(s) 206 from routine data management tasks.

The SoC(s) 204 may be an end-to-end platform with a flexible architecture that spans automation levels 3-5, thereby providing a comprehensive functional safety architecture that leverages and makes efficient use of computer vision and ADAS techniques for diversity and redundancy, provides a platform for a flexible, reliable driving software stack, along with deep learning tools. The SoC(s) 204 may be faster, more reliable, and even more energy-efficient and space-efficient than conventional systems. For example, the accelerator(s) 214, when combined with the CPU(s) 206, the GPU(s) 208, and the data store(s) 216, may provide for a fast, efficient platform for level 3-5 autonomous vehicles.

The technology thus provides capabilities and functionality that cannot be achieved by conventional systems. For example, computer vision algorithms may be executed on CPUs, which may be configured using high-level programming language, such as the C programming language, to execute a wide variety of processing algorithms across a wide variety of visual data. However, CPUs are oftentimes unable to meet the performance requirements of many computer vision applications, such as those related to execution time and power consumption, for example. In particular, many CPUs are unable to execute complex object detection algorithms in real-time, which is a requirement of in-vehicle ADAS applications, and a requirement for practical Level 3-5 autonomous vehicles.

In contrast to conventional systems, by providing a CPU complex, GPU complex, and a hardware acceleration cluster, the technology described herein allows for multiple neural networks to be performed simultaneously and/or sequentially, and for the results to be combined together to enable Level 3-5 autonomous driving functionality. For example, a CNN executing on the DLA or dGPU (e.g., the GPU(s) 220) may include a text and word recognition, allowing the supercomputer to read and understand traffic signs, including signs for which the neural network has not been specifically trained. The DLA may further include a neural network that is able to identify, interpret, and provides semantic understanding of the sign, and to pass that semantic understanding to the path planning modules running on the CPU Complex.

As another example, multiple neural networks may be run simultaneously, as is required for Level 3, 4, or 5 driving. For example, a warning sign consisting of “Caution: flashing lights indicate icy conditions,” along with an electric light, may be independently or collectively interpreted by several neural networks. The sign itself may be identified as a traffic sign by a first deployed neural network (e.g., a neural network that has been trained), the text “Flashing lights indicate icy conditions” may be interpreted by a second deployed neural network, which informs the vehicle's path planning software (preferably executing on the CPU Complex) that when flashing lights are detected, icy conditions exist. The flashing light may be identified by operating a third deployed neural network over multiple frames, informing the vehicle's path-planning software of the presence (or absence) of flashing lights. All three neural networks may run simultaneously, such as within the DLA and/or on the GPU(s) 208.

In some examples, a CNN for facial recognition and vehicle owner identification may use data from camera sensors to identify the presence of an authorized driver and/or owner of the vehicle 200. The always on sensor processing engine may be used to unlock the vehicle when the owner approaches the driver door and turn on the lights, and, in security mode, to disable the vehicle when the owner leaves the vehicle. In this way, the SoC(s) 204 provide for security against theft and/or carjacking.

In another example, a CNN for emergency vehicle detection and identification may use data from microphones 296 to detect and identify emergency vehicle sirens. In contrast to conventional systems, that use general classifiers to detect sirens and manually extract features, the SoC(s) 204 use the CNN for classifying environmental and urban sounds, as well as classifying visual data. In a preferred embodiment, the CNN running on the DLA is trained to identify the relative closing speed of the emergency vehicle (e.g., by using the Doppler Effect). The CNN may also be trained to identify emergency vehicles specific to the local area in which the vehicle is operating, as identified by GNSS sensor(s) 258. Thus, for example, when operating in Europe the CNN will seek to detect European sirens, and when in the United States the CNN will seek to identify only North American sirens. Once an emergency vehicle is detected, a control program may be used to execute an emergency vehicle safety routine, slowing the vehicle, pulling over to the side of the road, parking the vehicle, and/or idling the vehicle, with the assistance of ultrasonic sensors 262, until the emergency vehicle(s) passes.

The vehicle may include a CPU(s) 218 (e.g., discrete CPU(s), or dCPU(s)), that may be coupled to the SoC(s) 204 via a high-speed interconnect (e.g., PCIe). The CPU(s) 218 may include an X86 processor, for example. The CPU(s) 218 may be used to perform any of a variety of functions, including arbitrating potentially inconsistent results between ADAS sensors and the SoC(s) 204, and/or monitoring the status and health of the controller(s) 236 and/or infotainment SoC 230, for example.

The vehicle 200 may include a GPU(s) 220 (e.g., discrete GPU(s), or dGPU(s)), that may be coupled to the SoC(s) 204 via a high-speed interconnect (e.g., NVIDIA's NVLINK). The GPU(s) 220 may provide additional artificial intelligence functionality, such as by executing redundant and/or different neural networks, and may be used to train and/or update neural networks based on input (e.g., sensor data) from sensors of the vehicle 200.

The vehicle 200 may further include the network interface 224 which may include one or more wireless antennas 226 (e.g., one or more wireless antennas for different communication protocols, such as a cellular antenna, a Bluetooth antenna, etc.). The network interface 224 may be used to enable wireless connectivity over the Internet with the cloud (eq., with the server(s) 278 and/or other network devices), with other vehicles, and/or with computing devices (e.g., client devices of passengers). To communicate with other vehicles, a direct link may be established between the two vehicles and/or an indirect link may be established (e.g., across networks and over the Internet). Direct links may be provided using a vehicle-to-vehicle communication link. The vehicle-to-vehicle communication link may provide the vehicle 200 information about vehicles in proximity to the vehicle 200 (e.g., vehicles in front of, on the side of, and/or behind the vehicle 200). This functionality may be part of a cooperative adaptive cruise control functionality of the vehicle 200.

The network interface 224 may include a SoC that provides modulation and demodulation functionality and enables the controller(s) 236 to communicate over wireless networks. The network interface 224 may include a radio frequency front-end for up-conversion from baseband to radio frequency, and down conversion from radio frequency to baseband. The frequency conversions may be performed through well-known processes, and/or may be performed using super-heterodyne processes. In some examples, the radio frequency front end functionality may be provided by a separate chip. The network interface may include wireless functionality for communicating over LTE, WCDMA, UMTS, GSM, CDMA2000, Bluetooth, Bluetooth LE, Wi-Fi, Z-Wave, ZigBee, LoRaWAN, and/or other wireless protocols.

The vehicle 200 may further include data store(s) 228 which may include off-chip (e.g., off the SoC(s) 204) storage. The data store(s) 228 may include one or more storage elements including RAM, SRAM, DRAM, VRAM, Flash, hard disks, and/or other components and/or devices that may store at least one bit of data.

The vehicle 200 may further include GNSS sensor(s) 258. The GNSS sensor(s) 258 (e.g., GPS, assisted GPS sensors, differential GPS (DGPS) sensors, etc.), to assist in mapping, perception, occupancy grid generation, and/or path planning functions. Any number of GNSS sensor(s) 258 may be used, including, for example and without limitation, a GPS using a USB connector with an Ethernet to Serial (RS-232) bridge.

The vehicle 200 may further include RADAR sensor(s) 260. The RADAR sensor(s) 260 may be used by the vehicle 200 for long-range vehicle detection, even in darkness and/or severe weather conditions. RADAR functional safety levels may be ASIL B. The RADAR sensor(s) 260 may use the CAN and/or the bus 202 (e.g., to transmit data generated by the RADAR sensor(s) 260) for control and to access object tracking data, with access to Ethernet to access raw data in some examples. A wide variety of RADAR sensor types may be used. For example, and without limitation, the RADAR sensor(s) 260 may be suitable for front, rear, and side RADAR use. In some example, Pulse Doppler RADAR sensor(s) are used.

The RADAR sensor(s) 260 may include different configurations, such as long range with narrow field of view, short range with wide field of view, short range side coverage, etc. In some examples, long-range RADAR may be used for adaptive cruise control functionality. The long-range RADAR systems may provide a broad field of view realized by two or more independent scans, such as within a 250 m range. The RADAR sensor(s) 260 may help in distinguishing between static and moving objects, and may be used by ADAS systems for emergency brake assist and forward collision warning. Long-range RADAR sensors may include monostatic multimodal RADAR with multiple (e.g., six or more) fixed RADAR antennae and a high-speed CAN and FlexRay interface. In an example with six antennae, the central four antennae may create a focused beam pattern, designed to record the vehicle's 200 surroundings at higher speeds with minimal interference from traffic in adjacent lanes. The other two antennae may expand the field of view, making it possible to quickly detect vehicles entering or leaving the vehicle's 200 lane.

Mid-range RADAR systems may include, as an example, a range of up to 260 m (front) or 80 m (rear), and a field of perspective of up to 42 degrees (front) or 250 degrees (rear). Short-range RADAR systems may include, without limitation, RADAR sensors designed to be installed at both ends of the rear bumper. When installed at both ends of the rear bumper, such a RADAR sensor systems may create two beams that constantly monitor the blind spot in the rear and next to the vehicle.

Short-range RADAR systems may be used in an ADAS system for blind spot detection and/or lane change assist.

The vehicle 200 may further include ultrasonic sensor(s) 262. The ultrasonic sensor(s) 262, which may be positioned at the front, back, and/or the sides of the vehicle 200, may be used for park assist and/or to create and update an occupancy grid. A wide variety of ultrasonic sensor(s) 262 may be used, and different ultrasonic sensor(s) 262 may be used for different ranges of detection (e.g., 2.5 m, 4 m). The ultrasonic sensor(s) 262 may operate at functional safety levels of ASIL B.

The vehicle 200 may include LIDAR sensor(s) 264. The LIDAR sensor(s) 264 may be used for object and pedestrian detection, emergency braking, collision avoidance, and/or other functions. The LIDAR sensor(s) 264 may be functional safety level ASIL B. In some examples, the vehicle 200 may include multiple LIDAR sensors 264 (e.g., two, four, six, etc.) that may use Ethernet (e.g., to provide data to a Gigabit Ethernet switch).

In some examples, the LIDAR sensor(s) 264 may be capable of providing a list of objects and their distances for a 360-degree field of view. Commercially available LIDAR sensor(s) 264 may have an advertised range of approximately 200 m, with an accuracy of 2 cm-3 cm, and with support for a 200 Mbps Ethernet connection, for example. In some examples, one or more non-protruding LIDAR sensors 264 may be used. In such examples, the LIDAR sensor(s) 264 may be implemented as a small device that may be embedded into the front, rear, sides, and/or corners of the vehicle 200. The LIDAR sensor(s) 264, in such examples, may provide up to a 120-degree horizontal and 35-degree vertical field-of-view, with a 200 m range even for low-reflectivity objects. Front-mounted LIDAR sensor(s) 264 may be configured for a horizontal field of view between 45 degrees and 135 degrees.

In some examples, LIDAR technologies, such as 3D flash LIDAR, may also be used. 3D Flash LIDAR uses a flash of a laser as a transmission source, to illuminate vehicle surroundings up to approximately 200 m. A flash LIDAR unit includes a receptor, which records the laser pulse transit time and the reflected light on each pixel, which in turn corresponds to the range from the vehicle to the objects. Flash LIDAR may allow for highly accurate and distortion-free images of the surroundings to be generated with every laser flash. In some examples, four flash LIDAR sensors may be deployed, one at each side of the vehicle 200. Available 3D flash LIDAR systems include a solid-state 3D staring array LIDAR camera with no moving parts other than a fan (e.g., a non-scanning LIDAR device). The flash LIDAR device may use a 5 nanosecond class I (eye-safe) laser pulse per frame and may capture the reflected laser light in the form of 3D range point clouds and co-registered intensity data. By using flash LIDAR, and because flash LIDAR is a solid-state device with no moving parts, the LIDAR sensor(s) 264 may be less susceptible to motion blur, vibration, and/or shock.

The vehicle may further include IMU sensor(s) 266. The IMU sensor(s) 266 may be located at a center of the rear axle of the vehicle 200, in some examples. The IMU sensor(s) 266 may include, for example and without limitation, an accelerometer(s), a magnetometer(s), a gyroscope(s), a magnetic compass(es), and/or other sensor types. In some examples, such as in six-axis applications, the IMU sensor(s) 266 may include accelerometers and gyroscopes, while in nine-axis applications, the IMU sensor(s) 266 may include accelerometers, gyroscopes, and magnetometers.

In some embodiments, the IMU sensor(s) 266 may be implemented as a miniature, high performance GPS-Aided Inertial Navigation System (GPS/INS) that combines micro-electro-mechanical systems (MEMS) inertial sensors, a high-sensitivity GPS receiver, and advanced Kalman filtering algorithms to provide estimates of position, velocity, and attitude. As such, in some examples, the IMU sensor(s) 266 may enable the vehicle 200 to estimate heading without requiring input from a magnetic sensor by directly observing and correlating the changes in velocity from GPS to the IMU sensor(s) 266. In some examples, the IMU sensor(s) 266 and the GNSS sensor(s) 258 may be combined in a single integrated unit.

The vehicle may include microphone(s) 296 placed in and/or around the vehicle 200. The microphone(s) 296 may be used for emergency vehicle detection and identification, among other things.

The vehicle may further include any number of camera types, including stereo camera(s) 268, wide-view camera(s) 270, infrared camera(s) 272, surround camera(s) 274, long-range and/or mid-range camera(s) 298, and/or other camera types. The cameras may be used to capture image data around an entire periphery of the vehicle 200. The types of cameras used depends on the embodiments and requirements for the vehicle 200, and any combination of camera types may be used to provide the necessary coverage around the vehicle 200. In addition, the number of cameras may differ depending on the embodiment. For example, the vehicle may include six cameras, seven cameras, ten cameras, twelve cameras, and/or another number of cameras. The cameras may support, as an example and without limitation, Gigabit Multimedia Serial Link (GMSL) and/or Gigabit Ethernet. Each of the camera(s) is described with more detail herein with respect to FIG. 2A and FIG. 2B.

The vehicle 200 may further include vibration sensor(s) 242. The vibration sensor(s) 242 may measure vibrations of components of the vehicle, such as the axle(s). For example, changes in vibrations may indicate a change in road surfaces. In another example, when two or more vibration sensors 242 are used, the differences between the vibrations may be used to determine friction or slippage of the road surface (e.g., when the difference in vibration is between a power-driven axle and a freely rotating axle).

The vehicle 200 may include an ADAS system 238. The ADAS system 238 may include a SoC, in some examples. The ADAS system 238 may include autonomous/adaptive/automatic cruise control (ACC), cooperative adaptive cruise control (CACC), forward crash warning (FCW), automatic emergency braking (AEB), lane departure warnings (LDW), lane keep assist (LKA), blind spot warning (BSW), rear cross-traffic warning (RCTW), collision warning systems (CWS), lane centering (LC), and/or other features and functionality.

The ACC systems may use RADAR sensor(s) 260, LIDAR sensor(s) 264, and/or a camera(s). The ACC systems may include longitudinal ACC and/or lateral ACC. Longitudinal ACC monitors and controls the distance to the vehicle immediately ahead of the vehicle 200 and automatically adjust the vehicle speed to maintain a safe distance from vehicles ahead. Lateral ACC performs distance keeping, and advises the vehicle 200 to change lanes when necessary. Lateral ACC is related to other ADAS applications such as LCA and CWS.

CACC uses information from other vehicles that may be received via the network interface 224 and/or the wireless antenna(s) 226 from other vehicles via a wireless link, or indirectly, over a network connection (e.g., over the Internet). Direct links may be provided by a vehicle-to-vehicle (V2V) communication link, while indirect links may be infrastructure-to-vehicle (12V) communication link. In general, the V2V communication concept provides information about the immediately preceding vehicles (e.g., vehicles immediately ahead of and in the same lane as the vehicle 200), while the 12V communication concept provides information about traffic further ahead. CACC systems may include either or both 12V and V2V information sources. Given the information of the vehicles ahead of the vehicle 200, CACC may be more reliable and it has potential to improve traffic flow smoothness and reduce congestion on the road.

FCW systems are designed to alert the driver to a hazard, so that the driver may take corrective action. FCW systems use a front-facing camera and/or RADAR sensor(s) 260, coupled to a dedicated processor, DSP, FPGA, and/or ASIC, that is electrically coupled to driver feedback, such as a display, speaker, and/or vibrating component. FCW systems may provide a warning, such as in the form of a sound, visual warning, vibration and/or a quick brake pulse.

AEB systems detect an impending forward collision with another vehicle or other object, and may automatically apply the brakes if the driver does not take corrective action within a specified time or distance parameter. AEB systems may use front-facing camera(s) and/or RADAR sensor(s) 260, coupled to a dedicated processor, DSP, FPGA, and/or ASIC. When the AEB system detects a hazard, it typically first alerts the driver to take corrective action to avoid the collision and, if the driver does not take corrective action, the AEB system may automatically apply the brakes in an effort to prevent, or at least mitigate, the impact of the predicted collision. AEB systems, may include techniques such as dynamic brake support and/or crash imminent braking.

LDW systems provide visual, audible, and/or tactile warnings, such as steering wheel or seat vibrations, to alert the driver when the vehicle 200 crosses lane markings. A LDW system does not activate when the driver indicates an intentional lane departure, by activating a turn signal. LDW systems may use front-side facing cameras, coupled to a dedicated processor, DSP, FPGA, and/or ASIC, that is electrically coupled to driver feedback, such as a display, speaker, and/or vibrating component.

LKA systems are a variation of LDW systems. LKA systems provide steering input or braking to correct the vehicle 200 if the vehicle 200 starts to exit the lane.

BSW systems detects and warn the driver of vehicles in an automobile's blind spot. BSW systems may provide a visual, audible, and/or tactile alert to indicate that merging or changing lanes is unsafe. The system may provide an additional warning when the driver uses a turn signal. BSW systems may use rear-side facing camera(s) and/or RADAR sensor(s) 260, coupled to a dedicated processor, DSP, FPGA, and/or ASIC, that is electrically coupled to driver feedback, such as a display, speaker, and/or vibrating component.

RCTW systems may provide visual, audible, and/or tactile notification when an object is detected outside the rear-camera range when the vehicle 200 is backing up. Some RCTW systems include AEB to ensure that the vehicle brakes are applied to avoid a crash. RCTW systems may use one or more rear-facing RADAR sensor(s) 260, coupled to a dedicated processor, DSP, FPGA, and/or ASIC, that is electrically coupled to driver feedback, such as a display, speaker, and/or vibrating component.

Conventional ADAS systems may be prone to false positive results which may be annoying and distracting to a driver, but typically are not catastrophic, because the ADAS systems alert the driver and allow the driver to decide whether a safety condition truly exists and act accordingly. However, in an autonomous vehicle 200, the vehicle 200 itself must, in the case of conflicting results, decide whether to heed the result from a primary computer or a secondary computer (e.g., a first controller 236 or a second controller 236). For example, in some embodiments, the ADAS system 238 may be a backup and/or secondary computer for providing perception information to a backup computer rationality module. The backup computer rationality monitor may run a redundant diverse software on hardware components to detect faults in perception and dynamic driving tasks. Outputs from the ADAS system 238 may be provided to a supervisory MCU. If outputs from the primary computer and the secondary computer conflict, the supervisory MCU must determine how to reconcile the conflict to ensure safe operation.

In some examples, the primary computer may be configured to provide the supervisory MCU with a confidence score, indicating the primary computer's confidence in the chosen result. If the confidence score exceeds a threshold, the supervisory MCU may follow the primary computer's direction, regardless of whether the secondary computer provides a conflicting or inconsistent result. Where the confidence score does not meet the threshold, and where the primary and secondary computer indicate different results (e.g., the conflict), the supervisory MCU may arbitrate between the computers to determine the appropriate outcome.

The supervisory MCU may be configured to run a neural network(s) that is trained and configured to determine, based on outputs from the primary computer and the secondary computer, conditions under which the secondary computer provides false alarms. Thus, the neural network(s) in the supervisory MCU may learn when the secondary computer's output may be trusted, and when it cannot. For example, when the secondary computer is a RADAR-based FCW system, a neural network(s) in the supervisory MCU may learn when the FCW system is identifying metallic objects that are not, in fact, hazards, such as a drainage grate or manhole cover that triggers an alarm. Similarly, when the secondary computer is a camera-based LDW system, a neural network in the supervisory MCU may learn to override the LDW when bicyclists or pedestrians are present and a lane departure is, in fact, the safest maneuver. In embodiments that include a neural network(s) running on the supervisory MCU, the supervisory MCU may include at least one of a DLA or GPU suitable for running the neural network(s) with associated memory. In preferred embodiments, the supervisory MCU may comprise and/or be included as a component of the SoC(s) 204.

In other examples, ADAS system 238 may include a secondary computer that performs ADAS functionality using traditional rules of computer vision. As such, the secondary computer may use classic computer vision rules (if-then), and the presence of a neural network(s) in the supervisory MCU may improve reliability, safety and performance. For example, the diverse implementation and intentional non-identity makes the overall system more fault-tolerant, especially to faults caused by software (or software-hardware interface) functionality. For example, if there is a software bug or error in the software running on the primary computer, and the non-identical software code running on the secondary computer provides the same overall result, the supervisory MCU may have greater confidence that the overall result is correct, and the bug in software or hardware on primary computer is not causing material error.

In some examples, the output of the ADAS system 238 may be fed into the primary computer's perception block and/or the primary computer's dynamic driving task block. For example, if the ADAS system 238 indicates a forward crash warning due to an object immediately ahead, the perception block may use this information when identifying objects. In other examples, the secondary computer may have its own neural network which is trained and thus reduces the risk of false positives, as described herein.

The vehicle 200 may further include the infotainment SoC 230 (e.g., an in-vehicle infotainment system (IVI)). Although illustrated and described as a SoC, the infotainment system may not be a SoC, and may include two or more discrete components. The infotainment SoC 230 may include a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., LTE, Wi-Fi, etc.), and/or information services (e.g., navigation systems, rear-parking assistance, a radio data system, vehicle related information such as fuel level, total distance covered, brake fuel level, oil level, door open/close, air filter information, etc.) to the vehicle 200. For example, the infotainment SoC 230 may radios, disk players, navigation systems, video players, USB and Bluetooth connectivity, carputers, in-car entertainment, Wi-Fi, steering wheel audio controls, hands free voice control, a heads-up display (HUD), an HMI display 234, a telematics device, a control panel (e.g., for controlling and/or interacting with various components, features, and/or systems), and/or other components. The infotainment SoC 230 may further be used to provide information (e.g., visual and/or audible) to a user(s) of the vehicle, such as information from the ADAS system 238, autonomous driving information such as planned vehicle maneuvers, trajectories, surrounding environment information (e.g., intersection information, vehicle information, road information, etc.), and/or other information.

The infotainment SoC 230 may include GPU functionality. The infotainment SoC 230 may communicate over the bus 202 (e.g., CAN bus, Ethernet, etc.) with other devices, systems, and/or components of the vehicle 200. In some examples, the infotainment SoC 230 may be coupled to a supervisory MCU such that the GPU of the infotainment system may perform some self-driving functions in the event that the primary controller(s) 236 (e.g., the primary and/or backup computers of the vehicle 200) fail. In such an example, the infotainment SoC 230 may put the vehicle 200 into a chauffeur to safe stop mode, as described herein.

The vehicle 200 may further include an instrument cluster 232 (e.g., a digital dash, an electronic instrument cluster, a digital instrument panel, etc.). The instrument cluster 232 may include a controller and/or supercomputer (e.g., a discrete controller or supercomputer). The instrument cluster 232 may include a set of instrumentation such as a speedometer, fuel level, oil pressure, tachometer, odometer, turn indicators, gearshift position indicator, seat belt warning light(s), parking-brake warning light(s), engine-malfunction light(s), airbag (SRS) system information, lighting controls, safety system controls, navigation information, etc. In some examples, information may be displayed and/or shared among the infotainment SoC 230 and the instrument cluster 232. In other words, the instrument cluster 232 may be included as part of the infotainment SoC 230, or vice versa.

FIG. 2D is a system diagram for communication between cloud-based server(s) and the exemplar autonomous vehicle 200 of FIG. 2A, according to various embodiments. The system 276 may include server(s) 278, network(s) 290, and vehicles, including the vehicle 200. The server(s) 278 may include a plurality of GPUs 284(A)-284(H) (collectively referred to herein as GPUs 284), PCIe switches 282(A)-282(H) (collectively referred to herein as PCIe switches 282), and/or CPUs 280(A)-280(B) (collectively referred to herein as CPUs 280). The GPUs 284, the CPUs 280, and the PCIe switches may be interconnected with high-speed interconnects such as, for example and without limitation, NVLink interfaces 288 developed by NVIDIA and/or PCIe connections 286. In some examples, the GPUs 284 are connected via NVLink and/or NVSwitch SoC and the GPUs 284 and the PCIe switches 282 are connected via PCIe interconnects. Although eight GPUs 284, two CPUs 280, and two PCIe switches are illustrated, this is not intended to be limiting. Depending on the embodiment, each of the server(s) 278 may include any number of GPUs 284, CPUs 280, and/or PCIe switches. For example, the server(s) 278 may each include eight, sixteen, thirty-two, and/or more GPUs 284.

The server(s) 278 may receive, over the network(s) 290 and from the vehicles, image data representative of images showing unexpected or changed road conditions, such as recently commenced road-work. The server(s) 278 may transmit, over the network(s) 290 and to the vehicles, neural networks 292, updated neural networks 292, and/or map information 294, including information regarding traffic and road conditions. The updates to the map information 294 may include updates for the HD map 222, such as information regarding construction sites, potholes, detours, flooding, and/or other obstructions. In some examples, the neural networks 292, the updated neural networks 292, and/or the map information 294 may have resulted from new training and/or experiences represented in data received from any number of vehicles in the environment, and/or based on training performed at a datacenter (e.g., using the server(s) 278 and/or other servers).

The server(s) 278 may be used to train machine learning models (e.g., neural networks) based on training data. The training data may be generated by the vehicles, and/or may be generated in a simulation (e.g., using a game engine). In some examples, the training data is tagged (e.g., where the neural network benefits from supervised learning) and/or undergoes other pre-processing, while in other examples the training data is not tagged and/or pre-processed (e.g., where the neural network does not require supervised learning). Training may be executed according to any one or more classes of machine learning techniques, including, without limitation, classes such as: supervised training, semi-supervised training, unsupervised training, self-learning, reinforcement learning, federated learning, transfer learning, feature learning (including principal component and cluster analyses), multi-linear subspace learning, manifold learning, representation learning (including spare dictionary learning), rule-based machine learning, anomaly detection, and any variants or combinations therefor. Once the machine learning models are trained, the machine learning models may be used by the vehicles (e.g., transmitted to the vehicles over the network(s) 290, and/or the machine learning models may be used by the server(s) 278 to remotely monitor the vehicles.

In some examples, the server(s) 278 may receive data from the vehicles and apply the data to up-to-date real-time neural networks for real-time intelligent inferencing. The server(s) 278 may include deep-learning supercomputers and/or dedicated AI computers powered by GPU(s) 284, such as a DGX and DGX Station machines developed by NVIDIA. However, in some examples, the server(s) 278 may include deep learning infrastructure that use only CPU-powered datacenters.

The deep-learning infrastructure of the server(s) 278 may be capable of fast, real-time inferencing, and may use that capability to evaluate and verify the health of the processors, software, and/or associated hardware in vehicle 200. For example, the deep-learning infrastructure may receive periodic updates from the vehicle 200, such as a sequence of images and/or objects that the vehicle 200 has located in that sequence of images (e.g., via computer vision and/or other machine learning object classification techniques). The deep-learning infrastructure may run its own neural network to identify the objects and compare them with the objects identified by the vehicle 200 and, if the results do not match and the infrastructure concludes that the AI in the vehicle 200 is malfunctioning, the server(s) 278 may transmit a signal to the vehicle 200 instructing a fail-safe computer of the vehicle 200 to assume control, notify the passengers, and complete a safe parking maneuver.

For inferencing, the server(s) 278 may include the GPU(s) 284 and one or more programmable inference accelerators (e.g., NVIDIA's Tensor®). The combination of GPU-powered servers and inference acceleration may make real-time responsiveness possible. In other examples, such as where performance is less critical, servers powered by CPUs, FPGAs, and other processors may be used for inferencing.

### Controlling Autonomous Vehicles Using Language Models

FIG. 3 is a more detailed illustration of the language model driving assistant 130 of FIG. 1, according to various embodiments. As shown, the language model driving assistant 130 includes a traffic rule extractor 310, a planner 330, and a language model 320. Although the language model 320 is shown as being included in the language model driving assistant 130, in some embodiments, the language model 320 can be distinct from the language model driving assistant 130. For example, in some embodiments, the language model 320 can execute in a cloud computing environment and be accessed by the language model driving assistant 130 via an application programming interface (API).

In operation, the language model driving assistant 130 receives a scene description 302, a motion plan (“plan”) 304, a situation 306, and local traffic rules 316. The scene description 302 is a description of a current environment from the perspective of a vehicle. The motion plan 304 is a nominal execution plan for driving the vehicle. The situation 306 is a situation being encountered by the vehicle. In some embodiments, the situation defaults to “normal status” under normal circumstances, such as when no specific situation is input into language model driving assistant 130. Any other situation can be received in other cases, such as “someone honks at me,” “a car suddenly appears,” “a pedestrian suddenly appears,” “it rains heavily,” “there is some trash on the road,” “the road is kind of wet,” “it suddenly started raining,” etc. In some embodiments, the scene description 302, the motion plan 304, and the situation 306 can be received in text format. For example, the scene description 302, the motion plan 304, and/or the situation 306 could be input, by a user, as text via a keyboard or touchscreen. As another example, the scene description 302, the motion plan 304, and/or the situation 306 could be text that is generated from the speech of a user via any technically feasible speech-to-text technique. As yet another example, one or more of the scene description, the motion plan, or the situation could be generated using one or more trained machine learning models, such as a trained vision language model that generates the text for a scene description and/or situation given one or more images (or other sensor data) of the environment surrounding a vehicle, a language model (e.g., GPT-Driver) that is trained to generate high-level semantic descriptions of motion plans, and/or the like.

The traffic rule extractor 310 extracts portion(s) of the local traffic rules 316 based on the scene description 302, the motion plan 304, and the situation 306. The local traffic rules 316 can be obtained in any technically feasible manner, such as based on user input specifying the current geographical location, automatically based on the global positioning system (GPS) coordinates of the vehicle, etc. Although the local traffic rules 316 are shown as being input into the language model driving assistant 130 as a reference example, in some embodiments, local traffic rules can be included in the language model driving assistant 130. Extracting portion(s) of the local traffic rules 316 can be beneficial because passing all of the local traffic rules 316 to the language model 320 can be superfluous and, in some cases, not permitted by the language model 320. Further, extraneous information from the local traffic rules 316 can sometimes hurt the performance of the language model 320. In some embodiments, the language model driving assistant 130 can extract portion(s) of the local traffic rules 316 by (1) prompting the language model 320 for common traffic-related phrases within the scene description 302, the motion plan 304, and the situation 306; and (2) extracting paragraphs of the local traffic rules 316 that include the common traffic-related phrases. Illustratively, the traffic rule extractor 310 includes a prompt generator that generates a prompt 318. The prompt 318 asks the language model 320 for common traffic-related phrases in the scene description 302, the motion plan 304, and the situation 306, which are also included in the prompt 318. Given the prompt 318, the language model 320 outputs keywords 322 that include common traffic-related phrases. Any technically feasible language model 320 can be used in some embodiments, such as a trained large language model (LLM). In some embodiments, the language 320 can be a pre-trained model that is used in a zero-shot manner. In some embodiments other, the language model 320 can be specifically fine-tuned to generate driving instructions using additional training data.

The traffic rule extractor 310 also includes a paragraph extractor that extracts one or more paragraphs 324 in which the keyword(s) 322 appear from the local traffic rules 316. In some embodiments, the paragraph extractor 314 can search for the keyword(s) 322 in the local traffic rules 316. Then, the paragraph extractor 314 can extract the paragraph(s) 324 in which the keyword(s) are found from the local traffic rules 316. The paragraph extractor 314 can also divide the local traffic rules 316 into paragraphs before searching for the keyword(s) 322 and extracting the paragraph(s) 324. Although described herein primarily with respect to extracting paragraphs of the local traffic rules as a reference example, in some other embodiments, any suitable portion(s) (e.g., sentences) of the local traffic rules can be extracted. Further, in some other embodiments, the traffic rule extractor 310 can extract portion(s) of the local traffic rules 316 in any technically feasible manner, such as using an embedding search.

Given the extracted paragraph(s) 324, the scene description 302, the motion plan 304, and the situation 306, the planner 330 prompts the language model 320 to generate an updated plan 336, which the language model driving assistant 130 can then output. Illustratively, the planner 330 includes a prompt generator 332. The prompt generator 332 generates a prompt 334 that asks for driving instruction and includes the scene description, the motion plan, the situation, and the extracted paragraph(s) 324. The planner 332 inputs the prompt 334 into the language model 320, which outputs the updated plan 336. The updated plan 336 includes driving instructions that are specific to the scene description 302, the motion plan 304, and the situation 306, and the updated plan 336 adheres to the traffic rules in the extracted paragraph(s) 324.

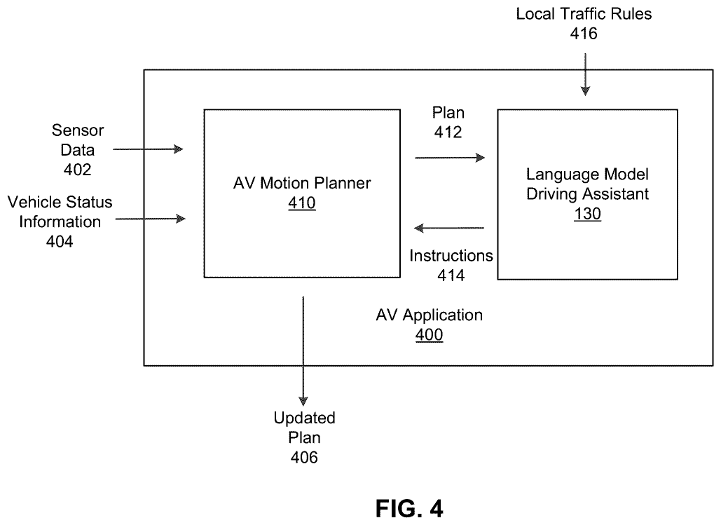

The language model driving assistant 130 outputs the updated motion plan 336 to provide driving assistance to a user or other software. In some embodiments, the updated motion plan 336 can be output as driving instructions to a user via a display device and/or speaker(s). In such cases, the driving instructions can be converted to an audio signal (e.g., via a text-to-speech technique) that is output via the speaker(s), and/or the driving instructions can be output as text via the display device. In some other embodiments, the updated motion plan 336 can be output to an AV motion planner that uses the updated motion plan 336 to generate a planned motion for the vehicle. In such cases, the planned motion can be transmitted to a controller (not shown) that controls the steering, accelerator, and/or breaks of the vehicle to achieve the planned motion, as described in greater detail below in conjunction with FIG. 4.

FIG. 4 illustrates an autonomous vehicle (AV) application 400 that includes the language model driving assistant 130 of FIG. 1, according to various embodiments. As shown, the AV application 400 includes an AV motion planner 410 and the language model driving assistant 130.

In operation, the AV application 400 receives sensor data 402 and vehicle status information 404. In some embodiments, the sensor data 402 can include image data, light detection and ranging (LIDAR) data, and/or RADAR data. In some embodiments, the vehicle status information 404 can include controller area network (CAN) bus data that can indicate the vehicle speed, acceleration, steering angle, braking, location, among other things. The AV motion planner 410 processes the sensor data 402 and the vehicle status information 404 to generate a motion plan (“plan”) 412 that includes text describing a planned motion and a corresponding future motion trajectory (e.g., [(x1, y1), . . . , (xN, yN)] of the vehicle. Any technically feasible AV motion planner can be used in some embodiments, including motion planners that take as input text and output text that includes the planned motion and the future motion trajectory. For example, in some embodiments, the AV motion planner 410 can be GPT-Driver, DriveGPT4, MotionLM, or the like.

The AV application 400 processes the motion plan 412 and local traffic rules 416, which can be received as input, using the language model driving assistant 130 to generate guidance 414 for the AV motion planner 410. In some embodiments, the language model driving assistant 130 performs the processing described above in conjunction with FIG. 3 to extract portion(s) of the local traffic rules 416 that include keywords relevant to the motion plan 412. In some embodiments, the extracted portion(s) of the local traffic rules 416 can also be relevant to a scene and a situation (not shown). The language model driving assistant 130 prompts a language model (e.g., language model 320) to generate driving instructions (“instructions”) 414. The driving instructions 414 are then fed back to the AV motion planner 410, which uses the instructions 414 along with the sensor data 404, and the vehicle status information 404, and/or the motion plan 412, to generate an updated plan 406. The updated plan 406 can include text describing a planned motion and a corresponding future motion trajectory (e.g., [(x1′, y1′), . . . , (xN′, yN′)] that modifies the previous motion plan 412 and associated motion trajectory to account for the driving instructions 414. The updated motion plan 406 and/or associated trajectory can, in turn, be transmitted to a controller (not shown) that controls the steering, accelerator, and/or breaks of a vehicle to achieve the planned motion and/or associated trajectory.

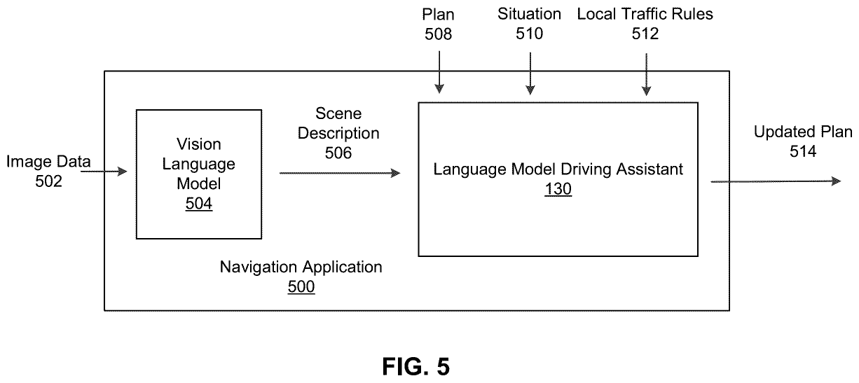

FIG. 5 illustrates a navigation application that includes the language model driving assistant 130 of FIG. 1, according to various embodiments. As shown, the navigation application 500 includes a vision language model 504 and the language model driving assistant 130. The vision language model 504 is a trained machine learning model that combines natural language processing and computer vision to understand and generate text about images. In operation, the navigation application 500 processes image data 502 of the environment surrounding a vehicle using the vision language model 504 to generate a scene description 506. For example, the navigation application 500 could prompt the vision language model 504 to describe the scene in the image data 502. The scene description 506 is similar to the scene description 302, described above in conjunction with FIG. 3, and includes a textual description of the environment from the perspective of the vehicle.

The navigation application 500 further processes the scene description 506 along with a plan 508, a situation 510, and local traffic rules 512, which are received as textual input (e.g., that is input via a keyboard or touchscreen or converted from an audio signal via a speed-to-text technique), using the language model driving assistant 130 to generate an updated plan 514. Alternative, in some embodiments, the vision language model 504 can also be used to generate the situation 510. In some embodiments, the language model driving assistant 130 performs the processing described above in conjunction with FIG. 3 to extract portion(s) of the local traffic rules 512 that include keywords relevant to the scene description 506, the plan 608, and the situation 510. Then, the language model driving assistant 130 prompts a language model (e.g., language model 320) to generate the updated plan 514 that accounts for the local traffic rules 412. Once generated, the navigation application 500 can output the updated plan 514 in any technically feasible manner, such as text instructions that are displayed via a display device and/or audio instructions that are output via one or more speaker devices.

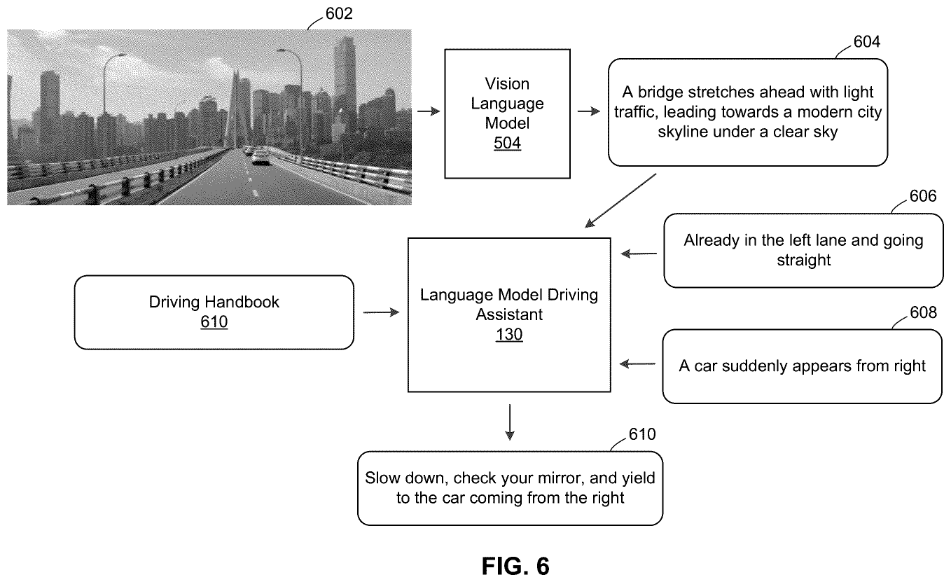

FIG. 6 illustrates how an exemplar plan can be generated by the navigation application 500 of FIG. 5, according to various embodiments. As shown, given an image 602 of the environment from the perspective of a vehicle, which can be captured (e.g., as part of a video) by a camera mounted on the vehicle, the navigation application 500 inputs the image 602 into the vision language model 504 to generate a scene description 604 of “A bridge stretches ahead with light traffic, leading towards a modern city skyline under a clear sky.” The navigation application 500 inputs, into the language model driving assistant 130, the scene description 604, a driving handbook 610 that includes the traffic code of the current location, a motion plan of “Already in the left lane and going straight” that is received from a user, and a situation of “A car suddenly appears from the right” that is also received from the user. Given such inputs, the language model driving assistant 130 performs the processing described above in conjunction with FIGS. 3 and 5 to (1) extract portion(s) of the driving handbook 610 that include keywords relevant to the scene description 604, the plan 606, and the situation 608; and (2) prompt a language model to generate an updated plan 610 of “Slow down, check your mirror, and yield to the car coming from the right” that accounts for the traffic rules in the extracted portion(s) of the driving handbook. The navigation application 500 can then output the updated plan 610 in any technically feasible manner, such as text instructions that are displayed via a display device and/or audio instructions that are output via one or more speaker devices.

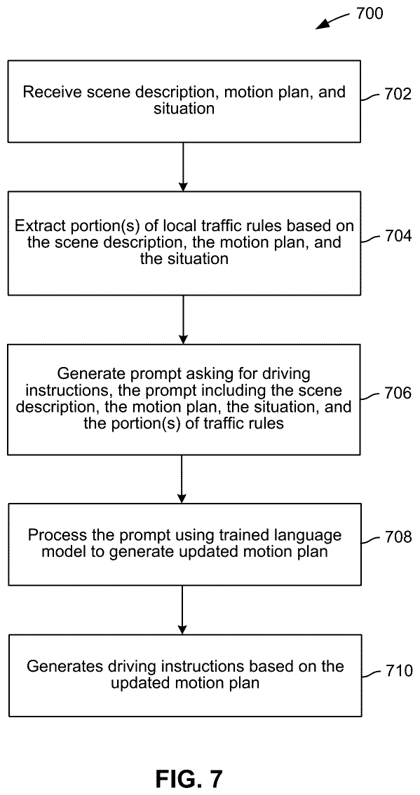

FIG. 7 is a flow diagram of method steps for providing driving assistance to an autonomous vehicle or a user, according to various embodiments. Although the method steps are described in conjunction with FIGS. 1-5, persons skilled in the art will understand that any system configured to perform the method steps, in any order, falls within the scope of the present disclosure.

As shown, a method 700 begins at step 702, where the language model driving assistant 130 receives a scene description, a motion plan, and a situation. The scene description is a description of a current environment from the perspective of a vehicle. The motion plan is a nominal execution plan for the vehicle. The situation is a situation being encountered by the vehicle. In some embodiments, the scene description, the motion plan, and the situation can be received in text format. For example, in some embodiments, the scene description, the motion plan, and the situation can be input as text by a user. As another example, in some embodiments, the scene description, the motion plan, and the situation can be text that is generated from the speech of a user via any technically feasible speech-to-text technique. As yet another example, in some embodiments, one or more of the scene description, the motion plan, and the situation can be generated using a machine learning model. For example, in some embodiments, the scene description and/or the situation can be generated by a vision language model that is given as input one or more images of the environment surrounding a vehicle, the motion plan can be generated by a language model that is specifically trained to generate motion plans and corresponding trajectories in text format, etc. as described above in conjunction with FIGS. 5-6.

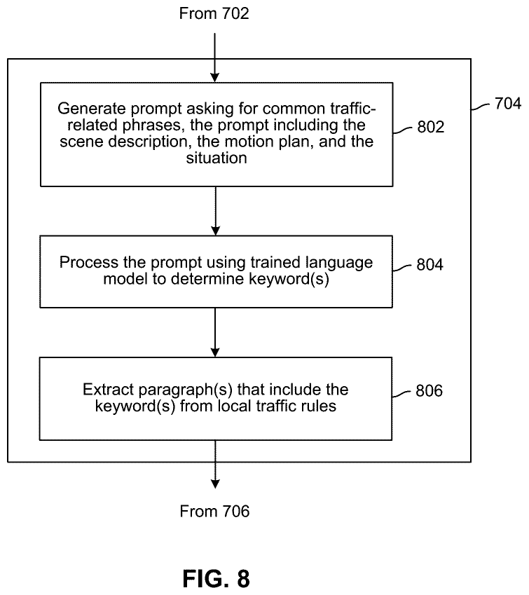

At step 704, the language model driving assistant 130 extracts portion(s) of local traffic rules based on the scene description, the motion plan, and the situation. In some embodiments, the language model driving assistant 130 can extract portion(s) of the local traffic rules by generating a prompt asking for common traffic-related phrases, the prompt including the scene description, the motion plan, and the situation; processing the prompt using a trained language model to determine one or more keywords; and extracting paragraph(s) that include the keyword(s) from local traffic rules, as described in greater detail below in conjunction with FIG. 8. In some other embodiments, the language model driving assistant 130 can extract portion(s) of the local traffic rules in any technically feasible manner, such as using an embedding search.

At step 706, the language model driving assistant 130 generates a prompt asking for driving instructions. In addition to asking for driving instructions, the prompt also includes the scene description, the motion plan, the situation, and the portion(s) of traffic rules that were extracted from the local traffic rules at step 704.

At step 708, the language model driving assistant 130 processes the prompt using a trained language model to generate an updated motion plan. In some embodiments, the language model driving assistant 130 can input the prompt generated at step 806 into the trained language model. Given such an input, the trained language model can output driving instructions that the language model driving assistant 130 uses as the updated motion plan. In some embodiments, the trained language model can be a pre-trained LLM that is not trained again. In some embodiments, the trained language model can be fine-tuned for generating driving instructions using additional training data.

At step 710, the language model driving assistant 130 generates driving instructions based on the updated motion plan. Any suitable driving assistance can be generated, in any technically feasible manner, in some embodiments. For example, in some embodiments, the driving instructions can be generated and output as text that is output to a user via a display device, and/or as audio that is output a user via one or more speaker devices. As another example, in some embodiments, the driving instructions can be generated as text that is consumed by other software and/or hardware, such as an AV motion planner that uses the driving instructions to generate a planned motion and/or trajectory that is, in turn, used to control a vehicle.

FIG. 8 is a flow diagram of method steps for extraction portion(s) of local traffic rules at step 704 of the method 700, according to various embodiments. Although the method steps are described in conjunction with FIGS. 1-5, persons skilled in the art will understand that any system configured to perform the method steps, in any order, falls within the scope of the present disclosure.

As shown, at step 802, the language model driving assistant 130 generates a prompt asking for common traffic-related phrases. The prompt asks for the common-traffic related phrases from the scene description, the motion plan, and the situation received at step 702, which can also be included in the prompt.

At step 804, the language model driving assistant 130 processes the prompt using a trained language model to determine one or more keywords. In some embodiments, the language model driving assistant 130 can input the prompt generated at step 802 into the trained language model. Given such an input, the trained language model outputs keyword(s) that include the common-traffic related phrases that the prompts asks for.

At step 806, the language model driving assistant 130 extracts one or more paragraphs that include the keyword(s) from local traffic rules. In some embodiments, the language model driving assistant 130 can search for the keyword(s) in the local traffic rules. In such cases, the language model driving assistant 130 can extract paragraphs in which the keyword(s) are found from the local traffic rules.

In sum, techniques are disclosed for generating driving instructions to autonomous vehicles or users. In some embodiments, a language model driving assistant receives as input text describing a scene, a plan for driving a vehicle, a current situation, and traffic rules for a geographic location in which the vehicle is being driven. Given such inputs, the language model driving assistant extracts one or more portions of the traffic rules that are relevant to the scene description, the plan, and/or the situation. For example, in some embodiments, the language model driving assistant can prompt a trained language model to extract, from the scene description, the plan, and/or the current situation, one or more keywords that include common traffic-related phrases. In such cases, the language model driving assistant can also search for the keyword(s) in the traffic rules, and then extract portions (e.g., paragraphs) of the traffic rules that include the keyword(s). The language model driving assistant further prompts the trained language model to generate an updated plan for driving the vehicle that accounts for the portion(s) of the traffic rules. The updated plan can be output as driving instructions to a user via a display device and/or speaker. Alternatively, the updated plan can be used to update an automatically generated motion plan, which can then be applied to control a vehicle.

At least one technical advantage of the disclosed techniques relative to the prior art is that the disclosed techniques enable a vehicle that is being controlled using a trained machine learning model to adapt to the traffic rules in different geographical locations. Accordingly, the disclosed techniques, when implemented to control a vehicle using a trained machine learning model, can result in the vehicle being driven in a manner that adheres to local traffic rules and is safer than what can typically be achieved using conventional machine learning models. Alternatively, the disclosed techniques, when implemented to respond to user input, can enable a user to drive more safely and in accordance with local traffic rules. These technical advantages represent one or more technological improvements over prior art approaches.

1. In some embodiments, a computer-implemented method for controlling a vehicle comprises receiving first text that includes a description of a scene and a first plan for driving a vehicle, extracting at least one portion of a set of traffic rules based on the description of the scene and the first plan, generating a first prompt that requests driving instructions and includes the description of the scene, the first plan, and the at least one portion of the set of traffic rules, processing the first prompt via a first trained language model to generate a second plan for driving the vehicle, and generating driving instructions based on the second plan.

2. The computer-implemented method of clause 1, further comprising receiving second text that indicates a situation, wherein extracting the at least one portion of the set of traffic rules is further based on the situation, and wherein the prompt further includes the situation.

3. The computer-implemented method of clauses 1 or 2, wherein extracting the at least one portion of the set of a traffic rules comprises generating a second prompt that asks for traffic phrases and includes the description of the scene and the first plan, processing the second prompt via the first trained language model to extract one or more keywords from the description of the scene and the first plan, and extracting, from the set of traffic rules, one or more paragraphs that include at least a first keyword that is included in the one or more keywords.

4. The computer-implemented method of any of clauses 1-3, wherein the driving instructions are transmitted to a trained planning model, and further comprising generating, by the trained planning model and based on the driving instructions, one or more trajectories for the vehicle, and causing one or more operations to control the vehicle to be performed based on the one or more trajectories.

5. The computer-implemented method of any of clauses 1-4, further comprising transmitting the driving instructions to a driver via a speaker device.

6. The computer-implemented method of any of clauses 1-5, further comprising displaying the driving instructions to a driver via a display device.

7. The computer-implemented method of any of clauses 1-6, further comprising processing image data associated with the vehicle using a vision language model to generate the description of the scene.

8. The computer-implemented method of any of clauses 1-7, further comprising generating, via a second trained language model, the first plan based on second text that indicates at least one of sensor data or status information associated with the vehicle.

9. The computer-implemented method of any of clauses 1-8, wherein the set of traffic rules are included in a driving handbook.

10. The computer-implemented method of any of clauses 1-9, wherein the first trained language model comprises a trained large language model.

11. In some embodiments, one or more non-transitory computer-readable media store instructions that, when executed by at least one processor, cause the at least one processor to perform the steps of receiving first text that includes a description of a scene and a first plan for driving a vehicle, extracting at least one portion of a set of traffic rules based on the description of the scene and the first plan, generating a first prompt that requests driving instructions and includes the description of the scene, the first plan, and the at least one portion of the set of traffic rules, processing the first prompt via a first trained language model to generate a second plan for driving the vehicle, and generating driving instructions based on the second plan.

12. The one or more non-transitory computer-readable media of clause 11, wherein the instructions, when executed by the at least one processor, further cause the at least one processor to perform the step of receiving second text that indicates a situation, wherein extracting the at least one portion of the set of traffic rules is further based on the situation, and wherein the prompt further includes the situation.

13. The one or more non-transitory computer-readable media of clauses 11 or 12, wherein extracting the at least one portion of a set of a traffic rules comprises generating a second prompt that asks for traffic phrases and includes the description of the scene and the first plan, processing the second prompt via the first trained language model to extract one or more keywords from the description of the scene and the first plan, and extracting, from the set of traffic rules, one or more paragraphs that include at least a first keyword that is included in the one or more keywords.

14. The one or more non-transitory computer-readable media of any of clauses 11-13, wherein the driving instructions are transmitted to a trained planning model, and the instructions, when executed by the at least one processor, further cause the at least one processor to perform the steps of generating, by the trained planning model and based on the driving instructions, one or more trajectories for the vehicle, and causing one or more operations to control the vehicle to be performed based on the one or more trajectories.

15. The one or more non-transitory computer-readable media of any of clauses 11-14, wherein the instructions, when executed by the at least one processor, further cause the at least one processor to perform the step of transmitting the driving instructions to a driver via an audio signal that is output by a speaker device.

16. The one or more non-transitory computer-readable media of any of clauses 11-15, wherein the instructions, when executed by the at least one processor, further cause the at least one processor to perform the step of transmitting the driving instructions to a driver via text that is displayed by a display device.

17. The one or more non-transitory computer-readable media of any of clauses 11-16, wherein the instructions, when executed by the at least one processor, further cause the at least one processor to perform the step of processing image data associated with the vehicle using a vision language model to generate the description of the scene.

18. The one or more non-transitory computer-readable media of any of clauses 11-17, wherein the instructions, when executed by the at least one processor, further cause the at least one processor to perform the step of generating, via a second trained language model, the first plan based on second text that indicates at least one of sensor data or status information associated with the vehicle.

19. The one or more non-transitory computer-readable media of any of clauses 11-18, wherein the first text and the first plan are received from at least one of a user or one or more trained machine learning models.

20. In some embodiments, a system comprises one or more memories storing instructions, and one or more processors that are coupled to the one or more memories and, when executing the instructions, are configured to receive first text that includes a description of a scene and a first plan for driving a vehicle, extract at least one portion of a set of traffic rules based on the description of the scene and the first plan, generate a first prompt that requests driving instructions and includes the description of the scene, the first plan, and the at least one portion of the set of traffic rules, process the first prompt via a first trained language model to generate a second plan for driving the vehicle, and generate driving instructions based on the second plan.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for controlling a vehicle, the method comprising:
receiving first text that includes a description of a scene and a first plan for driving a vehicle;
extracting at least one portion of a set of traffic rules based on the description of the scene and the first plan;
generating a first prompt that requests driving instructions and includes the description of the scene, the first plan, and the at least one portion of the set of traffic rules;
processing the first prompt via a first trained language model to generate a second plan for driving the vehicle; and
generating driving instructions based on the second plan.

2. The computer-implemented method of claim 1, further comprising receiving second text that indicates a situation, wherein extracting the at least one portion of the set of traffic rules is further based on the situation, and wherein the prompt further includes the situation.

3. The computer-implemented method of claim 1, wherein extracting the at least one portion of the set of a traffic rules comprises:
generating a second prompt that asks for traffic phrases and includes the description of the scene and the first plan;
processing the second prompt via the first trained language model to extract one or more keywords from the description of the scene and the first plan; and
extracting, from the set of traffic rules, one or more paragraphs that include at least a first keyword that is included in the one or more keywords.

4. The computer-implemented method of claim 1, wherein the driving instructions are transmitted to a trained planning model, and further comprising:
generating, by the trained planning model and based on the driving instructions, one or more trajectories for the vehicle; and
causing one or more operations to control the vehicle to be performed based on the one or more trajectories.

5. The computer-implemented method of claim 1, further comprising transmitting the driving instructions to a driver via a speaker device.

6. The computer-implemented method of claim 1, further comprising displaying the driving instructions to a driver via a display device.

7. The computer-implemented method of claim 1, further comprising processing image data associated with the vehicle using a vision language model to generate the description of the scene.

8. The computer-implemented method of claim 1, further comprising generating, via a second trained language model, the first plan based on second text that indicates at least one of sensor data or status information associated with the vehicle.

9. The computer-implemented method of claim 1, wherein the set of traffic rules are included in a driving handbook.

10. The computer-implemented method of claim 1, wherein the first trained language model comprises a trained large language model.

11. One or more non-transitory computer-readable media storing instructions that, when executed by at least one processor, cause the at least one processor to perform the steps of:
receiving first text that includes a description of a scene and a first plan for driving a vehicle;
extracting at least one portion of a set of traffic rules based on the description of the scene and the first plan;
generating a first prompt that requests driving instructions and includes the description of the scene, the first plan, and the at least one portion of the set of traffic rules;
processing the first prompt via a first trained language model to generate a second plan for driving the vehicle; and
generating driving instructions based on the second plan.

12. The one or more non-transitory computer-readable media of claim 11, wherein the instructions, when executed by the at least one processor, further cause the at least one processor to perform the step of receiving second text that indicates a situation, wherein extracting the at least one portion of the set of traffic rules is further based on the situation, and wherein the prompt further includes the situation.

13. The one or more non-transitory computer-readable media of claim 11, wherein extracting the at least one portion of a set of a traffic rules comprises:
generating a second prompt that asks for traffic phrases and includes the description of the scene and the first plan;
processing the second prompt via the first trained language model to extract one or more keywords from the description of the scene and the first plan; and
extracting, from the set of traffic rules, one or more paragraphs that include at least a first keyword that is included in the one or more keywords.

14. The one or more non-transitory computer-readable media of claim 11, wherein the driving instructions are transmitted to a trained planning model, and the instructions, when executed by the at least one processor, further cause the at least one processor to perform the steps of:
generating, by the trained planning model and based on the driving instructions, one or more trajectories for the vehicle; and
causing one or more operations to control the vehicle to be performed based on the one or more trajectories.

15. The one or more non-transitory computer-readable media of claim 11, wherein the instructions, when executed by the at least one processor, further cause the at least one processor to perform the step of transmitting the driving instructions to a driver via an audio signal that is output by a speaker device.

16. The one or more non-transitory computer-readable media of claim 11, wherein the instructions, when executed by the at least one processor, further cause the at least one processor to perform the step of transmitting the driving instructions to a driver via text that is displayed by a display device.

17. The one or more non-transitory computer-readable media of claim 11, wherein the instructions, when executed by the at least one processor, further cause the at least one processor to perform the step of processing image data associated with the vehicle using a vision language model to generate the description of the scene.

18. The one or more non-transitory computer-readable media of claim 11, wherein the instructions, when executed by the at least one processor, further cause the at least one processor to perform the step of generating, via a second trained language model, the first plan based on second text that indicates at least one of sensor data or status information associated with the vehicle.

19. The one or more non-transitory computer-readable media of claim 11, wherein the first text and the first plan are received from at least one of a user or one or more trained machine learning models.

20. A system, comprising:
one or more memories storing instructions; and
one or more processors that are coupled to the one or more memories and, when executing the instructions, are configured to:
receive first text that includes a description of a scene and a first plan for driving a vehicle,
extract at least one portion of a set of traffic rules based on the description of the scene and the first plan,
generate a first prompt that requests driving instructions and includes the description of the scene, the first plan, and the at least one portion of the set of traffic rules,
process the first prompt via a first trained language model to generate a second plan for driving the vehicle, and
generate driving instructions based on the second plan.
